(19) United States
(12) Patent Application Publication
(10) Pub. No.: US 2025/0183301 A1
(43) Pub. Date: Jun. 5, 2025

(54) SUB-ASSEMBLY FOR ALL SOLID SECONDARY BATTERY, ALL SOLID SECONDARY BATTERY, AND METHOD OF PREPARING THE SUB-ASSEMBLY

(71) Applicant: Samsung Electronics Co., Ltd., Suwon-si (KR)

(72) Inventors: Sewon KIM, Suwon-si (KR); Dongsu KO, Suwon-si (KR); Victor ROEV, Suwon-si (KR); Changhoon JUNG, Suwon-si (KR); Jusik KIM, Suwon-si (KR)

(21) Appl. No.: 18/964,956

(22) Filed: Dec. 2, 2024

(30) Foreign Application Priority Data
Nov. 30, 2023 (KR) 10-2023-0171828

(51) Int. Cl. H01M 4/583; H01M 4/02; H01M 4/04; H01M 4/133; H01M 4/62; H01M 10/0562

(52) U.S. Cl. CPC H01M 4/583; H01M 4/0416; H01M 4/133; H01M 4/625; H01M 10/0562; H01M 2004/021

(57) ABSTRACT

A sub-assembly for use in an all-solid secondary battery includes a solid electrolyte layer and an anode on the solid electrolyte layer. The anode includes a carbon active material layer between an anode current collector and the solid electrolyte layer, and a bonding layer between the solid electrolyte layer and the carbon active material layer and contacting a surface of the solid electrolyte layer. The bonding layer includes a plurality of carbon particles and a plurality of crystalline particles of a material having lithium (Li), carbon (C), and oxygen (O) atoms. An all-solid secondary batter includes a cathode and such a sub-assembly.

### CROSS-REFERENCE TO RELATED APPLICATION

This application claims priority to Korean Patent Application No. 10-2023-0171828, filed on Nov. 30, 2023, in the Korean Intellectual Property Office, and all the benefits accruing therefrom under 35 U.S.C. § 119, the content of which is incorporated herein by reference in its entirety.

### BACKGROUND

### 1. Field

The disclosure relates to a sub-assembly of an all solid secondary battery, an all solid secondary battery, and a method of manufacturing the sub-assembly.

### 2. Description of the Related Art

In order to develop a battery having high energy density and safety, an all solid secondary battery using a solid electrolyte layer instead of a combustible organic solvent electrolyte has been proposed.

Since the all solid secondary battery uses a solid electrolyte layer in an all solid rather than a liquid state as an electrolyte, a gap region or a void may exist between the solid electrolyte layer and the anode. As a result, interfacial resistance between the anode of the all solid secondary battery and the solid electrolyte layer may increase and charge/discharge characteristics may be degraded.

Therefore, there is a need for an all solid secondary battery with a new structure that can improve charging/discharging performance by improving contact characteristics while strengthening a mechanical structure between an anode and a solid electrolyte layer, and a method of manufacturing the same.

### SUMMARY

Provided is a sub-assembly of an all solid secondary battery that does not have short circuit issues and has improved high rate characteristics and life characteristics.

Provided are an all solid secondary battery including the sub-assembly and a method of manufacturing the sub-assembly.

Additional aspects will be set forth in part in the description which follows and, in part, will be apparent from the description, or may be learned by practice of the presented embodiments of the disclosure.

According to an aspect of an embodiment, a sub-assembly of an all solid secondary battery includes a solid electrolyte layer and an anode on the solid electrolyte layer, the sub-assembly including an anode current collector, a carbon active material layer between the anode current collector and the solid electrolyte layer, and a bonding layer between the solid electrolyte layer and the carbon active material layer and in contact with a surface of the solid electrolyte layer.

The bonding layer may include a plurality of first carbon particles and a plurality of crystalline particles of a material having lithium (Li), carbon (C), and oxygen (O) atoms.

At least a portion of the plurality of the first carbon particles or the second carbon particles may be coated with or surrounded by a coating layer including a material having lithium and oxygen atoms.

The first carbon particles of the carbon active material layer and the second carbon particles of the bonding layer may include a same carbon anode active material.

The bonding layer may further include a first binder, and the crystalline particles may contain a material derived from or determined based on a material of the solid electrolyte layer and a material of the first binder in the bonding layer.

The material of the solid electrolyte layer may include lithium and oxygen atoms, and the material of the first binder may include carbon and oxygen atoms.

The carbon active material layer further includes a second binder, and a content of the first binder in the bonding layer may be greater than a content of the second binder in the carbon active material layer.

An average particle diameter of the crystalline particles may be about 100 nm or less.

A surface of the solid electrolyte layer in contact with the bonding layer may have a plurality of microgrooves, and at least a portion of the crystalline particles may be disposed inside the microgrooves.

A thickness of the bonding layer may be about 1 μm or less.

The sub-assembly can further include a metal active material layer between the anode current collector and the carbon active material layer and including lithium or a metal alloyable with lithium may be further included.

The solid electrolyte layer may include an oxide solid electrolyte, a sulfide solid electrolyte, a polymer solid electrolyte, or a combination thereof.

An all solid secondary battery according to an embodiment may include a cathode including a cathode current collector and a cathode active material layer, and the sub-assembly described above.

A method of manufacturing a sub-assembly according to an embodiment may include applying a carbon material slurry including a carbon anode active material, a solvent, and a binder to a surface of a solid electrolyte layer and drying the carbon material slurry applied to the surface of the solid electrolyte layer.

In the drying of the carbon material slurry applied on the surface of the solid electrolyte layer, a sub-assembly with a bonding layer and a carbon active material layer on the surface of the solid electrolyte layer is formed, and the carbon active material layer includes a first plurality of carbon particles, and the bonding layer may include a second plurality of carbon particles and a plurality of crystalline particles of a material having lithium (Li), carbon (C), and oxygen (O) atoms.

Before the carbon material slurry is applied, the solid electrolyte layer may have a plurality of microgrooves formed on the surface of the solid electrolyte layer by surface treatment, and at least a portion of the crystalline particles may be formed in the plurality of microgrooves at the drying of the carbon material slurry.

The bonding layer may include the binder, and the crystalline particles may contain a material derived from or determined based on a material of the solid electrolyte layer and a material of the binder.

The carbon active material layer further includes the binder, and a content of the binder in the bonding layer may be greater than a content of the binder in the carbon active material layer.

In the drying of the carbon material slurry, a portion of the plurality of carbon particles of the bonding layer may be coated with or surrounded by a coating layer including a material having lithium and oxygen atoms.

The carbon particles of the carbon active material layer and the carbon particles of the bonding layer may include a same carbon active material.

The method can further include forming a metal active material layer on the anode current collector, and arranging the anode current collector so that the metal active material layer faces the carbon active material layer on the solid electrolyte layer arranged thereon, and bonding the metal active material layer to the carbon active material layer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view illustrating a schematic configuration of an embodiment of an all solid secondary battery;

FIG. 2 is cross-sectional view illustrating the sub-assembly of the all solid secondary battery of FIG. 1;

FIG. 3 is a diagram for explaining a configuration of each layer of the sub-assembly of FIG. 2;

FIG. 4 is a cross-sectional view illustrating a schematic configuration of an embodiment of a sub-assembly of an all solid secondary battery;

FIG. 5 is a diagram for schematically explaining a part of an embodiment of a process of manufacturing a sub-assembly of an all solid secondary battery;

FIG. 6 is a diagram for schematically explaining a process of bonding an anode current collector to the sub-assembly of FIG. 5;

FIG. 7 is a scanning electron microscope (SEM) analysis image of a sub-assembly according to an embodiment;

FIG. 8 is an enlarged view of a portion of FIG. 7;

FIG. 9 is an electron energy loss spectroscopy (ELS) image of a bonding layer adjacent to a surface of a solid electrolyte layer according to an embodiment;

FIG. 10 is a graph of Z″ (Ohm square centimeter, Ohm cm²) versus Z′ (Ohm square centimeter, Ohm cm²) showing charge/discharge characteristics of an all solid secondary battery including the sub-assembly according to Example 1;

FIG. 11l is a view is graph of Z″ (Ohm square centimeter, Ohm cm²) versus Z′ (Ohm square centimeter, Ohm cm²) showing charge/discharge characteristics of an all solid secondary battery including the sub-assembly according to Comparative Example 1;

FIG. 12l is a graph of areal capacity (milliampere hour per square centimeter, mAh/cm²) versus cycle number (#) showing life characteristics of the all solid secondary battery including the sub-assembly according to Example 1; and

FIG. 13 is a graph of areal capacity (milliampere hour per square centimeter, mAh/cm²) versus cycle number (#) showing life characteristics of the all solid secondary battery including the sub-assembly according to Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain various aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept described below may apply various transforms and may have various embodiments, and specific embodiments are illustrated in the drawings and described in the detailed description in detail. However, this is not intended to limit the inventive concept to a specific embodiment, and it should be understood that the present inventive concept includes all transforms, equivalents, or replacements included in the technical scope of the inventive concept.

The terms used hereinafter are used only to describe particular embodiments, and are not intended to limit the present inventive concepts. The expression of the singular includes the expression of the plural, unless the context clearly indicates otherwise.

In the present disclosure, the expression “at least one type,” “one type or more,” or “one or more” before the components does not mean that the list of all components may be supplemented and the individual components of the above description may be supplemented. In the present disclosure, the term “combination” includes a mixture, an alloy, a reaction product, and the like, unless otherwise stated. In the present disclosure, the term “include” means that other components may be further included rather than excluding other components unless otherwise stated. In the present disclosure, terms such as “first”, “second”, etc. are used to distinguish one element from another without indicating order, quantity, or importance. It will be understood that when an element is referred to as being “on” another element, it can be directly on the other element or intervening elements may be present therebetween. In contrast, when an element is referred to as being “directly on” another element, there are no intervening elements present. Unless otherwise indicated or explicitly refuted by context in the present disclosure, it should be interpreted as including both singular and plural. “Or” means “and/or” unless otherwise specified.

Throughout the present disclosure, “one embodiment”, “an embodiment”, and the like mean that specific elements described in connection with an embodiment are included in at least one embodiment described herein, and may or may not exist in other embodiments. It should also be understood that the elements described may be combined in any suitable manner in various embodiments.

Unless otherwise stated, all percentages, parts, ratio, etc. are by weight. In addition, when the amount, concentration, or other value or parameter is given as any one of a range, a preferred range or a list of desired upper limits and desired lower limits, it should be understood that this specifically discloses any range formed from any pair of any upper limit threshold or desired values and any lower limit threshold or desired values regardless of whether the scope is separately disclosed.

If a range of numerical values is mentioned herein, unless otherwise described, the range is intended to include its endpoint and all integers and fractions within that range. It is intended that the scope of the present disclosure is not limited to the specific values mentioned when defining the scope.

As used herein, the term “about” means within an acceptable deviation range for a particular value determined by one of ordinary skill in the art in view of errors associated with corresponding measurements and specific amounts of measurements (i.e., limits of the measurement system). For example, the term “about” may mean within one or more standard deviations, or within ±30%, ±20%, ±10%, or ±5% of a specified value.

Unless otherwise defined, all terms (including technical and scientific terms) used herein have the same meaning as those generally understood by those skilled in the art to which the present disclosure belongs. In addition, it will also be understood that terms such as those defined in commonly used dictionaries should be interpreted as having a meaning consistent with the meaning of the relevant description and the meaning of this disclosure, and should not be interpreted as idealized. Or it should not be interpreted in an overly formal sense.

An exemplary embodiment is described herein with reference to a cross-sectional view that is a schematic diagram of the idealized embodiment. Thus, the shape of the example may vary, for example, as a result of manufacturing technology and/or tolerance. Therefore, the embodiments described here should not be interpreted as being limited to a specific shape of the area described here, but should include, for example, variations in shape occurring during the manufacturing process. For example, areas illustrated or described as flat may generally have rough and/or nonlinear characteristics. In addition, the illustrated acute angle may be round. Therefore, the area illustrated in the drawing is inherently schematic, and its shape is not intended to illustrate the exact shape of the area and is not intended to limit the scope of this claim.

Hereinafter, a sub-assembly of an all solid secondary battery, an all solid secondary battery, and a method of manufacturing the all solid secondary battery will be described in more detail according to embodiments.

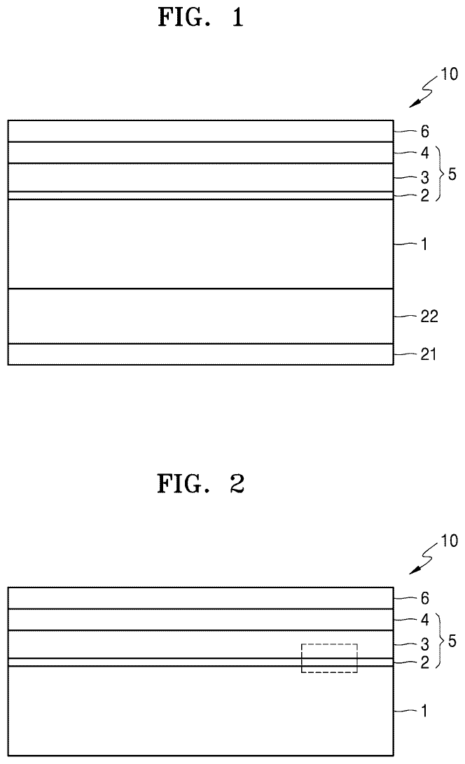

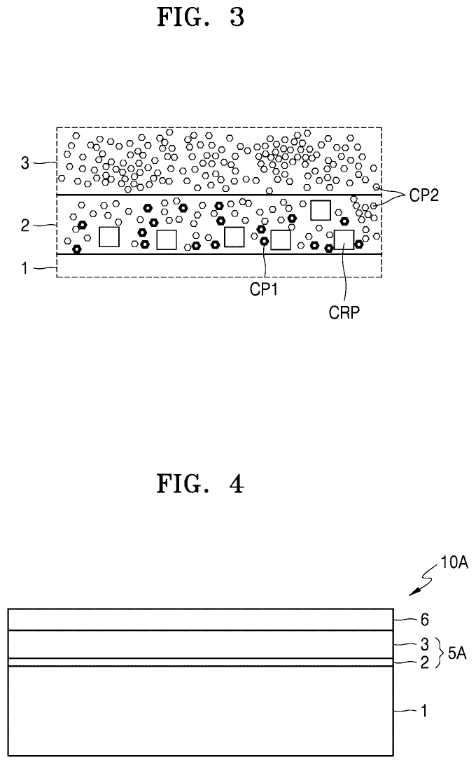

FIG. 1 is a schematic cross-sectional view illustrating an embodiment of an all solid secondary battery 100. FIG. 2 is a schematic cross-sectional view of the sub-assembly in the all solid secondary battery of FIG. 1. FIG. 3 is a diagram for explaining a configuration of each layer of the sub-assembly of FIG. 2. FIG. 4 is a schematic cross-sectional view illustrating an embodiment of a sub-assembly of an all solid secondary battery.

Referring to FIGS. 1 to 2, the all solid secondary battery 100 according to an embodiment is a secondary battery using a solid electrolyte as an electrolyte. For example, the all solid secondary battery may be a so-called all solid lithium ion secondary battery in which lithium ions move between a cathode layer and an anode layer.

However, the all solid secondary battery is not necessarily limited thereto, and may be other secondary batteries including a solid electrolyte layer in an all solid, not a liquid state, as an electrolyte. For example, an all solid secondary battery may include a lithium sulfur battery and a lithium air encapsulation layer when the all solid secondary battery includes a solid electrolyte layer.

The all solid secondary battery includes a cathode and a sub-assembly 10. The sub-assembly 10 may include a solid electrolyte layer 1 and an anode on the solid electrolyte layer 1. The sub-assembly 10 of the all solid secondary battery according to the embodiment may have a “Li-free” (or anode-free) structure in an initial state or a complete discharge state.

### Cathode

The cathode includes a cathode current collector 21 and a cathode active material layer 22.

The cathode current collector 21 may be a metal substrate. Examples of the metal substrate may include aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. The cathode current collector 21 may be in the form of a plate or a foil. The cathode current collector may be omitted.

The cathode active material layer 22 may include a cathode active material. Any cathode active material may be used without limitation as long as the cathode active material is normally used in a lithium battery. For example, the cathode active material may use at least one of composite oxides of a metal selected from cobalt, manganese, nickel, and a combination thereof and lithium. As specific examples, a compound represented by any one of the Chemical Formulas of: LiₐA_{1-b}B′_{b}D′₂ (where, 0.90≤a≤1.8 and 0≤b≤0.5.); LiₐE_{1-b}B′_{b}O_{2-c}D′_{c} (where, 0.90≤a≤1.8, 0≤b≤0.5, and 0≤c≤0.05.); LiE_{2-b}B′_{b}O_{4-c}D′_{c} (where, 0≤b≤0.5 and 0≤c≤0.05.); LiₐNi_{1-b-c}Co_{b}B′_{c}D′_{α} (where, 0.90≤a≤1.8, 0≤b≤0.5, 0≤c≤0.05, and 0<α≤2.); LiₐNi_{1-b-c}Co_{b}B′_{c}O_{2-α}F′_{α}(where, 0.90≤a≤1.8, 0≤b≤0.5, 0≤c≤0.05, and 0<α<2.); LiₐNi_{1-b-c}Co_{b}B′_{c}O_{2-α}F′₂ (where, 0.90≤a≤1.8, 0≤b≤0.5, 0≤c≤0.05, and 0<α<2.); LiₐNi_{1-b-c}Mn_{b}B′_{c}D′_{α}(where, 0.90≤a≤1.8, 0≤b≤0.5, 0≤c≤0.05, and 0<α≤2.); LiₐNi_{1-b-c}Mn_{b}B′CO₂₋ₐF′_{aα}(where, 0.90≤a≤1.8, 0≤b≤0.5, 0≤c≤0.05, and 0<α<2.); LiₐNi_{1-b-c}Mn_{b}B′CO₂₋ₐF′₂ (where, 0.90≤a≤1.8, 0≤b≤0.5, 0≤c≤0.05, and 0<α<2.); LiₐNi_{b}E_{c}G_{d}O₂ (where, 0.90≤a≤1.8, 0≤b≤0.9, 0≤c≤0.5, and 0.001≤d≤0.1.); LiₐNi_{b}Co_{c}Mn_{d}GeO₂ (where, 0.90≤a≤1.8, 0≤b≤0.9, 0≤c≤0.5, 0≤d≤0.5, and 0.001≤e≤0.1.); LiₐNiG_{b}O₂ (where, 0.90≤a≤1.8 and 0.001≤b≤0.1.); LiₐCoG_{b}O₂ (where, 0.90≤a≤1.8 and 0.001≤b≤0.1.); LiₐMnG_{b}O₂ (where, 0.90≤a≤1.8 and 0.001≤b≤0.1.); LiₐMn2G_{b}O₄ (where, 0.90≤a≤1.8 and 0.001≤b≤0.1.);QO₂; QS₂; LiQS₂; V₂O₅; LiV₂O₂; Lil′O₂; LiNiVO₄; Li_{(3-f)}J₂(PO₄)₃ (0≤f≤2); Li_{(3-f)}Fe₂(PO₄)₃ (0≤f≤2); and LiFePO₄ may be used. In the above chemical formulas, A is Ni, Co, Mn, or a combination thereof; B′ is Al, Ni, Co, Mn, Cr, Fe, Mg, Sr, V, rare earth elements, or a combination thereof; D′ is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof. For example, the cathode active material may include at least one of lithium cobalt oxide, lithium nickel oxide, lithium nickel cobalt oxide, lithium nickel cobalt aluminum oxide, lithium nickel cobalt manganese oxide, lithium manganese oxide, lithium iron phosphate oxide, nickel sulfide, copper sulfide, lithium sulfide, iron oxide, or vanadium oxide. For example, the cathode active material may be LiCoO₂, LiMnₓO₂ₓ(x=1, 2), LiNi₁₋ₓMnₓO₂ₓ (0<x<1), Ni_{1-x-y}CoₓMn_{y}O₂ (0≤x≤0.5 and 0≤y≤0.5), LiFePO₄, TiS₂, FeS₂, TiS₃, FeS₃ or the like.

The cathode active material layer 22 may further include an ionic liquid electrolyte. The ionic liquid electrolyte may be non-volatile. An ionic liquid refers to a salt in a liquid state at room temperature or a molten salt at room temperature, which has a melting point below room temperature and consists of only ions. The ionic liquid may be one selected from compounds containing: a) one or more cations of ammonium-based, pyrrolidinium-based, pyridinium-based, pyrimidinyl-based, imidazolium-based, piperidinium-based, pyrazolium-based, oxazolium-based, pyridazinium-based, phosphonium-based, sulfonium-based, or triazolium-based cations; and b) one or more anions of BF⁴⁻, PF₆⁻, AsF₆₋, SbF₆⁻, AlCl₄⁻, HSO₄⁻, ClO₄⁻, CH₃SO₃⁻, CF₃CO₂⁻, Cl⁻, Br⁻, I⁻, SO₄⁻, CF₃SO₃⁻, (FSO₂)₂N^{-, (C}₂F₅SO₂)₂N⁻, (C₂F₅SO₂)(CF₃SO₂)N⁻, or (CF₃SO₂)₂N⁻. For example, the ionic liquid may be one or more of N-methyl-N-propylpyrrolidinium bis(trifluoromethanesulfonyl) imide N-butyl-N-methylpyrrolidium bis(3-trifluoromethylsulfonyl)imide, 1-butyl-3-methylimidazolium bis(trifluoromethylsulfonyl) amide, or 1-ethyl-3-methylimidazolium bis(trifluoromethylsulfonyl) amide. The ionic liquid ionic liquid may be a polymer and contain repeating units containing: a) one or more cations of ammonium-based, pyrrolidinium-based, pyridinium-based, pyrimidinyl-based, imidazolium-based, piperidinium-based, pyrazolium-based, oxazolium-based, pyridazinium-based, phosphonium-based, sulfonium-based, or triazolium-based cations; and b) one or more anions of BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)₂N⁻, Cl⁻, Br⁻, I⁻, SO₄⁻, CF₃SO⁻, (C₂F₅SO₂)₂N⁻, (C₂F₅SO₂)(CF₃SO₂) N⁻, NO₃⁻, Al₂Cl7⁻, (CF₃SO₂)₃C⁻, (CF₃)₂PF₄⁻, (CF₃)₃PF₃⁻, (CF₃)₄PF₂⁻, (CF₃)₅ PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, or (O(CF₃)₂C₂(CF₃)₂O)₂PO⁻.

The ionic liquid electrolyte may be filled in pores of a surface of the solid electrolyte layer 1 contacting the cathode active material layer 22. The content of the ionic liquid electrolyte may be about 0.1 to about 20 wt %, about 0.1 to about 15 wt %, about 0.1 to about 10 wt %, or about 0.1 to about 5 wt % based on 100 wt % of the cathode active material layer 22 which does not include the ionic liquid electrolyte. By including an ionic liquid electrolyte, the ion conductivity and the charge/discharge characteristics of the battery may be improved.

The cathode active material layer 22 may further include a conductive material and a binder. For example, the conductive material may include carbon black, carbon fiber, graphite, or a combination thereof. For example, the carbon black may be acetylene black, ketjen black, super P carbon, channel black, furnace black, lamp black, thermal black, or a combination thereof. Graphite may be natural graphite or artificial graphite. A combination including at least one of the aforementioned may be used. The cathode active material layer 22 may additionally include a conductive material having a different composition than the conductive material described above in addition to the conductive material described above. The additional conductive material may be: an electrically conductive fiber, such as metal fiber; metal powder, such as aluminum powder, or nickel powder; a conductive whisker, such as zinc oxide or potassium titanate; a polyethylene derivative; a fluorocarbon powder; or a combination thereof. The content of the conductive material may be in a range of about 1 wt % to about 10 wt %, for example, about 2 wt % to about 7 wt %, based on 100 wt % of the cathode active material. When the amount of the conductive material is within this range, for example, about 1 wt % to about 10 wt %, the electrical conductivity of the cathode may be appropriate.

The binder may improve the adhesion between the components of the cathode and the adhesion between the cathode active material layer 22 and the cathode current collector 21. Examples of the binder may include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or a combination thereof. The content of the binder may be in a range of about 1 wt % to about 10 wt %, for example, in a range of about 2 wt % to about 7 wt %, based on 100 wt % of the cathode active material. When the content of the binder is within this range, the adhesive force of the cathode active material layer 22 to the cathode current collector 21 may be further improved, and a decrease in energy density of the cathode active material layer may be suppressed.

A solvent may be used to form a cathode active material composition used to form the cathode active material layer. As a solvent, N-methylpyrrolidone, acetone, water, etc. may be used. The contents of the cathode active material, the conductive material, the binder, and the solvent are the levels commonly used in lithium batteries.

A plasticizer may be added to the cathode active material composition to form pores inside the cathode active material layer.

### Solid Electrolyte Layer

The solid electrolyte layer 1 may include an oxide-based solid electrolyte (also referred to as “oxide solid electrolyte”), a sulfide-based solid electrolyte (also referred to as “sulfide solid electrolyte”), a polymer-based solid electrolyte (also referred to as “polymer solid electrolyte”), or a combination thereof.

Examples of the oxide-based solid electrolyte may include at least one of Li_{1+x+y}AlₓTi₂₋ₓSi_{y}P_{3-y}O₁₂ (0<x<2 and 0≤y<3), BaTiO₃, Pb(Zr,Ti)O₃(PZT), Pb₁₋ₓLaₓZr_{1-y}Ti_{y}O₃(PLZT) (0≤x<1 and 0≤y<1), PB(Mg₃Nb_{2/3})O₃-PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₆PO₄, LiₓTi_{y}(PO₄)₃ (0<x<2 and 0<y<3), LixAlyTiz (PO₄)₃ (0<x<2, 0<y<1, and 0<z<3), Li_{1+x+y}(Al, Ga)ₓ(Ti, Ge)₂₋ₓSi_{y}P_{3-y}O₁₂ (0≤x≤1 and 0≤y≤1), LiₓLa_{y}TiO₃ (0<x<2 and 0<y<3), Liz-xLasZr2-xTaxO12 (LLZO: Ta) (0≤x<1), Li₇₋₃ₓAlₓLa₃Zr₂O₁₂ (LLZO:Al) (0≤x<1), Li2O, LiOH, Li₂CO₃, LiAlO₂, LiZO-Al₂O₃-SiO₂-P₂O₅-TiO₂-GeO₂, or Li₃₊ₓLa₃M₂O₁₂ (M=Te, Nb, or Zr, and x is an integer of 1 to 10).

The oxide-based solid electrolyte may be produced by a sintering method, a casting method, or the like.

For example, the oxide-based solid electrolyte may be a garnet-based solid electrolyte. For example, the garnet-based solid electrolyte may include an oxide represented by Chemical Formula 1.

(LiₓM1_{y})(M2)_{3-δ}(M3)_{2-ω}O_{12-z}X_{z} <Chemical Formula 1>

In Chemical Formula 1, 6≤x≤8, 0≤y≤2, −0.2<δ<0.2, and −0.2>ω<0.2, 0<z<2,
M1 is a monovalent cation, a divalent cation, a trivalent cation, or a combination thereof,
M2 is a monovalent cation, a divalent cation, a trivalent cation, or a combination thereof,
M3 is a monovalent cation, a divalent cation, a trivalent cation, a tetravalent cation, a pentavalent cation, a hexavalent cation or a combination thereof, and
X is a monovalent anion, a divalent anion, a trivalent anion or a combination thereof.

In Chemical Formula 1, examples of monovalent cations include Na, K, Rb, Cs, H, Fr, and the like, and divalent cations include, for example, Mg, Ca, Ba, Sr, and the like. Examples of trivalent cations include In, Sc, Cr, Au, B, Al, Ga, and the like, and examples of tetravalent cations include Sn, Ti, Mn, Ir, Ru, Pd, Mo, Hf, Ge, V, Si, and the like. Examples of pentavalent cations include Nb, Ta, Sb, V, and P.

M1 is, for example, hydrogen (H), iron (Fe), gallium (Ga), aluminum (AI), boron (B), beryllium (Be), or a combination thereof. M2 is La (lanthanum), barium (Ba), calcium (Ca), strontium (Sr), yttrium (Y), bismuth (Bi), praseodymium (Pr), neodymium (Nd), actinium (Ac), samarium (Sm), gadolinium (Gd) or a combination thereof. M3 is zirconium (Zr), hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (AI) or a combination thereof.

In Chemical Formula 1, the monovalent anion used as X is a halogen atom, a pseudohalogen, or a combination thereof, the divalent anion is S^{2 -} or Se^{2 -}, and the trivalent anion is, for example, N³⁻.

In Chemical Formula 1, 6.6≤x≤8, 6.7≤x≤7.5, or 6.8≤x≤7.1.

For example, the garnet-based solid electrolyte may include an oxide represented by Chemical Formula 2.

(LiₓM1_{y})(Laₐ₁M2ₐ₂)_{3-δ}(Zr_{b1}M3_{b2})_{2-ω}O_{12-z}X_{z} <Chemical Formula 2>

In Chemical Formula 2, M1 is hydrogen (H), iron (Fe), gallium (Ga), aluminum (AI), boron (B), beryllium (Be), or a combination thereof,
M2 is barium (Ba), calcium (Ca), strontium (Sr), yttrium (Y), bismuth (Bi), praseodymium (Pr), neodymium (Nd), actinium (Ac), samarium (Sm), gadolinium (Gd) or a combination thereof,
M3 is hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (Al) or a combination thereof,
6≤x≤8, 0≤y<2, −0.2≤δ≤0.2, and −0.2≤ω≤0.2, 0≤z≤2,
a1+a2=1, 0<a1≤1, and 0≤a2<,
b1+b2=1, 0<b1≤1, and 0≤b2<1, and
X is a monovalent anion, a divalent anion, a trivalent anion, or a combination thereof.

In Chemical Formula 2, the monovalent anion used as X is a halogen atom, a pseudohalogen, or a combination thereof, the divalent anion is S₂₋ or Se²⁻, and the trivalent anion is, for example, N³⁻.

In Chemical Formula 2, 6.6≤x≤8, 6.7≤x≤7.5, or 6.8≤x≤7.1.

In the present disclosure, “pseudohalogen” is a molecule composed of two or more electronegative atoms similar to halogen in a free state, and generates anions similar to halide ions. Examples of pseudohalogens are cyanide, cyanate, thiocyanate, azide, or a combination thereof.

The halogen atom may be, for example, iodine (I), chlorine (Cl), bromine (Br), fluorine (F), or a combination thereof.

The trivalent anion is, for example, N³⁻.

In Chemical Formula 2, M is Al, Ga, In, Si, Ge, Sn, Sb, Bi, Sc, Y, Ti, Hf, V, Nb, Ta, W, or a combination thereof.

According to another example, the garnet-based solid electrolyte may be an oxide represented by Chemical Formula 3.

Li₃₊ₓLa₃Zr₂₋ₐMₐO₁₂ <Chemical Formula 3>

In Chemical Formula 3, M is Al, Ga, In, Si, Ge, Sn, Sb, Bi, Sc, Y, Ti, Hf, V, Nb, Ta, W, or a combination thereof, where x is a number of 1 to 10, and 0≤a<2.

Examples of the garnet-based solid electrolyte may include Li₇La₃Zr₂O₁₂, Li_{6.5}La₃Zr_{1.5}Ta_{0.5}O₁₂, and the like.

The garnet-based solid electrolyte can have an ion conductivity of 1 mS·cm⁻¹ or more and may be manufactured in the form of pellets, tapes, and layers. The garnet- based solid electrolyte may be manufactured to have various thicknesses in a wide temperature range.

The sulfide-based solid electrolyte is not particularly limited as long as the sulfide-based solid electrolyte contains sulfur(S) or a sulfur-based element Se or Te and has ion conductivity. For example, the sulfide-based solid electrolyte may include at least one of Li₂S-P₂S₅, Li₂S-P₂S₅-LiX (X is a halogen element), Li₂S-P₂S₅-Li₂O, Li₂S-P₂S₅-Li₂O-Lil, Li₂S-SiS₂, Li₂S-SiS₂-Lil, Li₂S-SiS₂-LiBr, Li₂S-SiS₂-LiCl, Li₂S-SiS₂-B₂S₃-Lil, Li₂S-SiS₂-P₂S₅-Lil, Li₂S-B₂S₃, Li₂S-P₂S₅-ZₘSₙ (m and n are positive numbers, and Z is one of Ge, Zn and Ga), Li₂S-GeS₂, Li₂S-SiS₂-Li₃PO₄, or Li₂S-SiS₂-LiₚMO_{q} (p and q are positive numbers, and M is one of P, Si, Ge, B, Al, Ga and In). When the sulfide-based solid electrolyte material includes Li₂S-P₂S₅, the mixture molar ratio of Li₂S and P₂S₅ may be selected in a range of about 50:50 to about 90:10, may be selected in a range of about 60:40 to about 90:10, or may be selected in a range of about 75:25 to about 90:10. The sulfide-based solid electrolyte may be prepared by treating a source material (e.g., Li₂S, P₂S₅, etc.) by a melt quenching method, a mechanical milling method, or the like. In addition, the calcinations process may be performed after the above treatment.

The sulfide-based solid electrolyte may include a compound represented by Chemical Formula 4.

LiₐM1ₓPS_{y}M2_{z}M3_{w} <Chemical Formula 4>

In Chemical Formula 4, M1 is at least one metal element other than Li selected from Groups 1 to 15 of the periodic table,
M2 is at least one element selected from Group 17 of the periodic table, and
M3 is SOₙ, 4≤a≤8, 0≤x<1, 3≤y≤7, 0<z≤5, 0≤w<2, and 1.5≤n≤5.

In Chemical Formula 4, 0<z≤5, 0<z≤4, 0<z≤3, 0<z≤2, 0.2≤z≤1.8, 0.5≤z≤1.8, 1.0≤z≤1.8, or 1.0≤z≤1.5.

In Chemical Formula 4, 5≤a≤8, 0≤x≤0.7, 4≤y≤7, 0<z≤2, and 0≤w≤0.5, for example, 5≤a≤7, 0≤x≤0.5, 4≤y≤6, 0<z≤2, and 0≤w≤0.2, for example, 5.5≤a≤7, 0≤x≤0.3, 4.5≤y≤6, 0.2≤z≤1.8, and 0≤w≤0.1, 5.5≤a≤6, 0≤x≤0.05, 4.5≤y≤5, 1.0≤z≤1.5, and 0≤w≤0.1.

In the compound represented by Chemical Formula 4, M1 may include, for example, Na, K, Mg, Ag, Cu, Hf, In, Ti, Pb, Sb, Fe, Zr, Zn, Cr, B, Sn, Ge, Si, Zr, Ta, Nb, V, Ga, Al, As, or a combination thereof. M1 may be, for example, a monovalent cation or a divalent cation.

In the compound represented by Chemical Formula 4, M2 may include, for example, F, Cl, Br, I, or a combination thereof. M2 may be, for example, a monovalent anion.

In the compound represented by Chemical Formula 4, SOₙ of M3 may be, for example, S₄O₆, S₃O₆, S₂O₃, S₂O₄, S₂O₅, S₂O₆, S₂O₇, S₂O₈, SO₄, SO₅, or a combination thereof. SOₙ may be, for example, a divalent anion. SOₙ²⁻ may be, for example, S₄O₆²⁻, S₃O₆²⁻, S₂O₃²⁻, S₂O₄²⁻, S₂O₅²⁻, S₂O₆²⁻, S₂O₇²⁻, S₂O₈²⁻, SO₄²⁻, SO₅²⁻, or a combination thereof.

For example, the compound represented by Chemical Formula 4 may be a compound selected from compounds represented by the following Chemical Formulae 4a and 4b.

LiₐPS_{y}M2_{z}M3_{w} <Chemical Formula 4a>

In Chemical Formula 4a, M2 is at least one element selected from Group 17 of the periodic table, and M3 is SOₙ, where 4≤a≤8, 3≤y≤7, 0<z≤5, 0<w<2, and 1.5≤n≤5.

LiₐM1ₓPS_{y}M2_{z}M3_{w} <Chemical Formula 4b>

In Chemical Formula 4b, M1 is at least one metal element other than Li selected from Groups 1 to 15 of the periodic table,
M2 is at least one element selected from Group 17 of the periodic table, and
M3 is SOₙ, and 4≤a≤8, 0<x<1, 3≤y≤7, 0<z≤5, 0<w<2, and 1.5≤n≤5.

In Chemical Formulae 4a and 4b, 0<z≤5, 0<z≤4, 0<z≤3, 0<z≤2, 0.2≤z≤1.8, 0.5≤z≤1.8, 1.0≤z≤1.8, or 1.0≤z≤1.5. In Chemical Formulas 4a and 4b, 5≤a≤8, 4≤y≤7, 0<z≤2, and 0w≤0.5, 5.5≤a≤7, 4.5≤y≤6, 0.2≤z≤1.8, and 0w≤0.1, 0.5≤z≤1.8, or 1.0≤z≤1.8.

For example, the compound represented by Chemical Formula 4 may be a compound represented by Chemical Formula 5 below.

Li_{7-mxv-z}M4ᵥPS_{6-z}M5_{z1}M6_{z2} <Chemical Formula 5>

In Chemical Formula 5, M4 is Na, K, Mg, Ag, Cu, Hf, In, Ti, Pb, Sb, Fe, Zr, Zn, Cr, B, Sn, Ge, Si, Zr, Ta, Nb, V, Ga, Al, As, or a combination thereof, m is an oxidation number of M4, and M5 and M6 are each independently F, Cl, Br, or I, where 0<v<0.7, 0<z1<2, 0<z2<1, 0<z<2, z=z1+z2, and 1≤m≤2.

For example, 0<v≤0.7, 0<z1<2, 0≤z2≤0.5, 0<z<2, and z=z1+z2. For example, 0<v≤0.5, 0<z1<2, 0≤z2≤0.5, 0<z<2, and z=z1+z2. For example, 0<v≤0.3, 0<z1≤1.5, 0≤z2≤0.5, 0.2≤z≤1.8, and z=z1+z2. For example, 0<v≤0.1, 0<z1≤1.5, 0≤z2≤0.5, 0.5≤z≤1.8, and z=z1+z2. For example, 0<v≤0.05, 0<z1≤1.5, 0≤z2≤0.2, 1.0≤z≤1.8, and z=z1+z2. M4 may be, for example, one metal element or two metal elements.

For example, the compound represented by Chemical Formula 5 may include one halogen element or two halogen elements.

For example, the compound represented by Chemical Formula 5 may be a solid ion conductor compound represented by Chemical Formulae 5a to 5f below.

Li_{7-z}PS_{6-z}M5_{z1}M6_{z2} <Chemical Formula 5a>

Li_{7-v-z}NaᵥPS_{6-z}M5_{z1}M6_{z} <Chemical Formula 5b>

Li_{7-v-z}KᵥPS_{6-z}M5_{z1}M6_{z2} <Chemical Formula 5c>

Li_{7-v-z}CuᵥPS_{6-z}M5_{z1}M6_{z} <Chemical Formula 5d>

Li_{7-v-z}MgᵥPS_{6-z}M5_{z1}M6_{z2} <Chemical Formula 5e>

Li_{7-v-z}AgᵥPS_{6-z}M5_{z1}M6_{z2} <Chemical Formula 5f>

In the above Chemical Formulae, M5 and M6 are each independently F, Cl, Br, or I, and
0<v<0.7, 0<z1<2, 0≤z2<1, 0<z<2, and z=z1+z2.

In the above Chemical Formulae 5a to 5f, each independently, for example, 0<v≤0.7, 0<z1<2, 0≤z2≤0.5, 0<z<2, and z=z1+z2, 0<v≤0.5, 0<z1<2, 0≤z2≤0.5, 0<z<2, and z=z1+z2, 0<v≤0.3, 0<z1≤1.5, 0≤z2≤0.5, 0.2≤z≤1.8, and z=z1+z2, 0<v≤0.05, 0<z1≤1.5, 0≤z2≤0.2, 1.0≤z≤1.8, and z=z1+z2, for example, 0<v≤0.05, 0<z1≤1.5, 0≤z2≤0.2, 1.0≤z≤1.5, and z=z1+z2. In Chemical Formula 5b, v=0.

The compound represented by Chemical Formula 4 may be, for example, a compound represented by the following Chemical Formulae:
Li_{7-z}PS_{6-z}F_{z1}, Li_{7-z}PS_{6-z}Cl_{z1}, Li_{7-z}PS_{6-z}Br_{z1}, Li_{7-z}PS_{6-z}I_{z1}, Li_{7-z}PS_{6-z}F_{z1}Cl_{z2}, Li_{7-z}PS_{6-z}Fz1Br_{z2}, Li_{7-z}PS_{6-z}F_{z1}I_{z2}, Li_{7-z}PS_{6-z}Cl_{z1}Br_{z2}, Li_{7-z}PS_{6-z}Cl_{z1}I_{z2}, Li_{7-z}PS_{6-z}Cl_{z1}F_{z2}, Li_{7-z}PS_{6-z}Br_{z 1}I_{z2}, Li_{7-z}PS_{6-z}Br_{z1}F_{z2}, Li_{7-z}PS_{6-z}Br_{z1}Cl_{z2}, Li_{7-z}PS_{6-z}I_{z1}F_{z2}, Li_{7-z}PS_{6-z}I_{z1}Cl_{z2}, Li_{7-z}PS_{6-z}I_{z 1}Br_{z2}, Li_{7-v-z}NaᵥPS_{6-z}F_{z1}, Li_{7-v-z}NaᵥPS_{6-z}Cl_{z1}, Li_{7-v-z}NaᵥPS_{6-z}Br_{z1}, Li_{7-v-z}NaᵥPS_{6-z}I_{z1}, Li_{7-v-z}NaᵥPS_{6-z}F_{z1}Cl_{z2}, Li_{7-v-z}NaᵥPS_{6-z}F_{z1}Br_{z2}, Li_{7-v-z}NaᵥPS_{6-z}F_{z1}I_{z2}, Li_{7-v-z}NaᵥPS_{6-z}Cl_{z1}Br_{z2}, Li_{7-v-z}NaᵥPS_{6-z}Cl_{z1}I_{z2}, Li_{7-v-z}NaᵥPS_{6-z}Cl_{z1}F_{z2}, Li_{7-v-z}NaᵥPS_{6-z}Br_{z1}I_{z2}, Li_{7-v-z}NaᵥPS_{6-z}Br_{z1}F_{z2}, Li_{7-v-z}NaᵥPS_{6-z}Br_{z1}Cl_{z2}, Li_{7-v-z}NaᵥPS_{6-z}I_{z1}F_{z2}, Li_{7-v-z}NaᵥPS_{6-z}I_{z1}Cl_{z2}, Li_{7-v-z}NaᵥPS_{6-z}I_{z1}Br_{z2}, Li_{7-v-z}KᵥPS_{6-z}F_{z1}, Li_{7-v-z}KᵥPS_{6-z}Cl_{z1}, Li_{7-v-z}KᵥPS_{6-z}Br_{z1}, Li_{7-v-z}KᵥPS_{6-z}I_{z1},
Li_{7-v-z}KᵥPS_{6-z}F_{z1}Cl_{z2}, Li_{7-v-z}KᵥPS_{6-z}F_{z1}Br_{z2}, Li_{7-v-z}KᵥPS_{6-z}F_{z1}I_{z2}, Li_{7-v-z}KᵥPS_{6-z}Cl_{z1}Br_{z2}, Li_{7-v-z}KᵥPS_{6-z}Cl_{zz}I_{z2}, Li_{7-v-z}KᵥPS_{6-z}Cl_{z1}F_{z2}, Li_{7-v-z}KᵥPS_{6-z}Br_{z1}I_{z2}, Li_{7-v-z}KᵥPS_{6-z}Br_{z1}F_{z2}, Li_{7-v-z}KᵥPS_{6-z}Br_{z1}Cl_{z2}, Li_{7-v-z}KᵥPS_{6-z}I_{z1}F_{z2}, Li_{7-v-z}KᵥPS_{6-z}I_{z1}Cl_{z2}, Li_{7-v-z}KᵥPS_{6-z}I_{z1} Br_{z2},
Li_{7-v-z}CuᵥPS_{6-z}F_{z1}, Li_{7-v-z}CuᵥPS_{6-z}Cl_{z1}, Li_{7-v-z}CuᵥPS_{6-z}Br_{z1}, Li_{7-v-z}CuᵥPS_{6-z}I_{z1}, Li_{7-v- z}CuᵥPS_{6-z}F_{z1}Cl_{z2}, Li_{7-v-z}CUᵥPS_{6-z}F_{z1}Br_{z2}, Li_{7-v-z}CUᵥPS_{6-z}F_{z1}I_{z2}, Li_{7-v-z}CuᵥPS_{6-z}Cl_{z1}Br_{z2}, Li_{7-v-z}CuᵥPS_{6-z}Cl_{z1}I_{z2}, Li_{7-v-z}CuᵥPS_{6-z}Cl_{z1}F₂₂, Li_{7-v-z}CuᵥPS_{6-z}Br_{z1}I_{z2}, Li_{7-v-z}CuᵥPS_{6-z}Br_{z1}F_{z2}, Li_{7-v-z}CuᵥPS_{6-z}Br_{z1}Cl_{z2}, Li_{7-v-z}CuᵥPS_{6-z}I_{z1}F_{z2}, Li_{7-v-z}CUᵥPS_{6-z}I_{z1}Cl_{z2}, Li_{7-v-z}CUᵥPS_{6-z}I_{z1} Br_{z2},
Li_{7-v-z}MgᵥPS_{6-z}F_{z1}, Li_{7-v-z}MgᵥPS_{6-z}Cl_{z1}, Li_{7-v-z}MgᵥPS_{6-z}Br_{z1}, Li_{7-v-z}MgᵥPS_{6-z}I_{z1},
Li_{7-v-z}MgᵥPS_{6-z}F_{z1}Cl_{z2}, Li_{7-v-z}MgᵥPS_{6-z}F_{z1}Br_{z2}, Li_{7-v-z}MgᵥPS_{6-z}F_{z1}I_{z2}, Li_{7-v-z}MgᵥPS_{6-z}Cl_{z 1}Br_{z2}, Li_{7-v-z}MgᵥPS_{6-z}Cl_{z1}I_{z2}, Li_{7-v-z}MgᵥPS_{6-z}Cl_{z1}F_{z2}, Li_{7-v-z}MgᵥPS_{6-z}Br_{z1}I_{z2}, Li_{7-v-z}MgᵥPS_{6-z}Br_{z 1}F_{z2}, Li_{7-v-z}MgᵥPS_{6-z}Br_{z1}Cl_{z2}, Li_{7-v-z}MgᵥPS_{6-z}I_{z1}F₂₂, Li_{7-v-z}MgᵥPS_{6-z}I_{z1}Cl_{z2}, Li_{7-v-z}MgᵥPS_{6-z}I_{z 1}Br_{z2},
Li_{7-v-z}AgᵥPS_{6-z}F_{z1}, Li_{7-v-z}AgᵥPS_{6-z}Cl_{z1}, Li_{7-v-z}AgᵥPS_{6-z}Br_{z1}, Li_{7-v-z}AgᵥPS_{6-z}I_{z1}, Li_{7-v-z}AgᵥPS_{6-z}F_{z1}Cl_{z2}, Li_{7-v-z}AgᵥPS_{6-z}F_{z1}Br_{z2}, Li_{7-v-z}AgᵥPS_{6-z}F_{z1}I_{z2}, Li_{7-v-z}AgᵥPS_{6-z}Cl_{z1}Br_{z2}, Li_{7-v-z}AgᵥPS_{6-z}Cl_{z1}I_{z2}, Li_{7-v-z}AgᵥPS_{6-z}Cl_{z1}F₂₂, Li_{7-v-z}AgᵥPS_{6-z}Br_{z1}I_{z2}, Li_{7-v-z}AgᵥPS_{6-z}Br_{z1}F_{z2}, Li_{7-v-z}AgᵥPS_{6-z}Br_{z1}Cl_{z2}, Li_{7-v-z}AgᵥPS_{6-z}I_{z1}F₂₂, Li_{7-v-z}AgᵥPS_{6-z}I_{z1}Cl_{z2}, or Li_{7-v-z}AgᵥPS_{6-z}I_{z1}Br_{z2}.

In the above Chemical Formulae, each independently, 0<v<0.7, 0<z1<2, 0<z2<1, 0<z<2 and z=z1+z2, for example, 0<v≤0.7, 0<z1<2, 0<z2≤0.5, 0<z<2, and z=z1+z2, 0<v≤0.3, 0<z1≤1.5, 0<z2≤0.5, 0.2≤z≤1.8 and z=z1+z2, 0<v≤0.05, 0<z1≤1.5, 0<z2≤0.2, 1.0≤z≤1.8 and z=z1+z2, or 0<v≤0.05, 0<z1≤1.5, 0<z2≤0.2, 1.0≤z≤1.5 and z=z1+z2. In the above Chemical Formulae, v=0, z1=0, or z2=0 when there is no v, z1, or z2. For example, if z1=0, z=z2. For example, if z2=0, z=z1.

The compound represented by Chemical Formula 4 may belong to, for example,

a cubic crystal system, and more specifically, may belong to an F-43m space group. In addition, as described above, the compound represented by Chemical Formula 4 may be an argyrodite-type sulfide having an argyrodite-type crystal structure. The compound represented by Chemical Formula 4 may further improve lithium ion conductivity and electrochemical stability to lithium metal by including, for example, at least one of a monovalent cation and a divalent cation, or a heterogeneous halogen, substituted in a part of a lithium site in an azirodite-type crystal structure, or a SOₙ anion substituted in a halogen site in the azirodite-type crystal structure.

The compound represented by Chemical Formula 4 is, for example, Li₆PS₅Cl.

In the disclosure, the sulfide-based solid electrolyte may be an argyrodite-type compound including one or more selected from Li₇₋ₓPS₆₋ₓClₓ (0≤x≤2), Li₇₋ₓPS₆-xBrₓ (0≤x≤2), and Li₇₋ₓPS₆₋ₓIₓ (0≤x≤2). In particular, the sulfide-based solid electrolyte including a solid electrolyte may be an argyrodite-type compound including one or more of Li₆PS₅Cl, Li₆PS₅Br or Li₆PS₅l.

The sulfide-based solid electrolyte may be in the form of powder or molded article. The solid electrolyte in the form of a molded article may be in the form of, for example, pellets, sheets, thin layers, etc., but is not limited thereto and may have various forms depending on the use.

Examples of the polymer-based solid electrolyte may include polyethylene oxide, polypropylene oxide, polystyrene (PS), polyphosphogenes, polysiloxane, polyvinylidene fluoride-co-hexafluoropropylene (PVDF-HFP), polyacrylonitrile (PAN), or a combination thereof. The ion conductivity of the polymer-based solid electrolyte may be achieved by local segmental motion of the polymer. By mixing polyether with a plasticizer salt, and sometimes a small amount of a liquid plasticizer, the polymer-based solid electrolyte may be prepared. Such an electrolyte may produce a thin layer by a solvent evaporation coating method. However, the embodiments are not limited thereto, and it is possible to use a polymer-based solid electrolyte that may be used in the art.

As necessary, the solid electrolyte may further include a binder. The binder included in the solid electrolyte layer 1 may be, for example, styrene butadiene rubber (SBR), polytetrafluoroethylene, polyvinylidene fluoride, polyethylene, or the like, but is not limited thereto, and any suitable binder in the field of technology may be used.

### Anode

An anode may include an anode current collector 6 and an intermediate layer 5 between the anode current collector 6 and the solid electrolyte layer 1. The intermediate layer 5 may be arranged in the order of a bonding layer 2, a carbon-based active material layer 3 (also referred to as “carbon active material layer”), and a metal-based active material layer 4 (also referred to as “metal active material layer”) from the solid electrolyte layer 1 to the anode current collector 6.

Examples of the anode current collector 6 may include copper (Cu), aluminum (AI), nickel (Ni), titanium (Ti), cobalt (Co), or stainless steel. The anode current collector 6 may include an alloy or coating material of one or two or more of Cu, Al, Ni, Ti, Co, or stainless steel. The anode current collector 6 may be in the form of a plate or a foil.

FIG. 3 is a diagram for explaining a configuration of a partial region of the sub-assembly 10 of FIG. 2.

Referring to FIGS. 2 and 3, the carbon-based active material layer 3 may be arranged between the anode current collector 6 and the solid electrolyte layer 1. The bonding layer 2 may be arranged between the solid electrolyte layer 1 and the carbon-based active material layer 3. The metal-based active material layer 4 may be arranged between the anode current collector 6 and the carbon-based active material layer 3.

The carbon-based active material layer 3 may include a plurality of carbon particles CP2. The plurality of carbon particles CP2 may include a carbon-based anode active material (also referred to as “carbon anode active material”). The carbon-based anode active material may include amorphous carbon. The amorphous carbon may be, for example, carbon black (CB), acetylene black (AB), furnace black (FB), Ketjen black (KB), graphene, carbon nanotube, carbon nanofiber, or the like, but is not limited thereto, and may all be classified as amorphous carbon in the art.

The carbon-based active material layer 3 may include a binder. The binding strength of the plurality of carbon particles CP2 may be increased by the binder.

For example, the binder may include an aqueous binder. Examples of the aqueous binder may include at least one polymer of polyvinyl alcohol, polyacrylic acid, polymethacrylic acid, polyvinyl alcohol grafted polyacrylic acid, or polyvinyl alcohol grafted polymethacrylic acid, or a copolymer thereof. Other examples of the aqueous binder may include carboxylmethyl cellulose, styrene butadiene rubber, and the like.

In the example described above, an aqueous binder is used as an example of the binder. However, the type of the binder is not necessarily limited to the aqueous binder, and a non-aqueous binder may be used if necessary. Examples of the non-aqueous binder may include PolyVinyliDeneFluoride, or the like, which is a fluorine-based binder.

The content of the binder in the carbon-based active material layer 3 may be about 0.1 wt % to about 15 wt % based on the total weight of the carbon-based active material layer 3. The content of the binder in the carbon-based active material layer 3 may be about 0.1 wt % to about 5 wt % based on the total weight of the carbon-based active material layer 3.

The carbon-based active material layer 3 has a characteristic of alleviating the volume change of the intermediate layer 5 during charging and discharging. However, the carbon-based active material layer 3 can have a less than desirable interfacial adhesive force with the solid electrolyte layer 1. Accordingly, in a structure in which the carbon-based active material layer 3 is in direct contact with the solid electrolyte layer 1, interfacial resistance between the carbon-based active material layer 3 and the solid electrolyte layer 1 may increase.

At least some layers of the intermediate layer 5 may be layers directly formed on the solid electrolyte layer 1. In another expression, at least some layers of the intermediate layer 5 may be formed through a drying step after being applied in the form of a slurry on the solid electrolyte layer 1 instead of the anode current collector 6 in the manufacturing process.

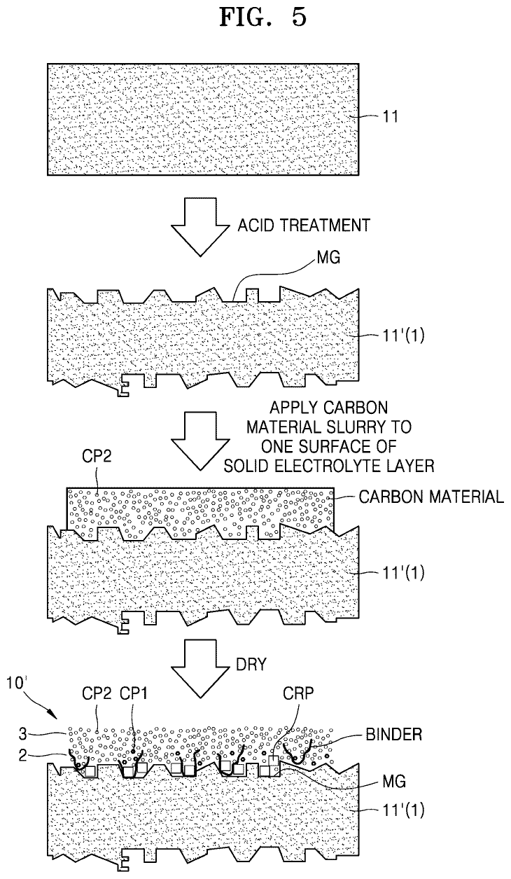

For example, the bonding layer 2 and the carbon-based active material layer 3 may be layers directly formed on the solid electrolyte layer 1. For example, in the process of directly forming the carbon-based active material layer 3 on the solid electrolyte layer 1, the bonding layer 2 is formed between the solid electrolyte layer 1 and the carbon-based active material layer 3, thereby improving the interfacial bonding strength between the solid electrolyte layer 1 and the anode. A method of manufacturing the sub-assembly 10 in which the bonding layer 2 is formed is described below with reference to FIG. 5.

In the anode of the all solid secondary battery according to the embodiment, the bonding layer 2 having a material similar to a material of the carbon-based active material layer 3 and having excellent interfacial adhesive force may be formed between the solid electrolyte layer 1 and the carbon-based active material layer 3. The bonding layer 2 is between the carbon-based active material layer 3 and the solid electrolyte layer 1 and may improve interfacial adhesive force between the anode and the solid electrolyte layer 1.

The bonding layer 2 may have an interfacial resistance with the solid electrolyte layer 1 that is less than or equal to a predetermined value. The bonding layer 2 may have an interfacial resistance of about 20 ohm·cm² or less with the solid electrolyte layer 1. The interfacial resistance between the bonding layer 2 and the solid electrolyte layer 1 is less than the interfacial resistance between the carbon-based active material layer 3 and the solid electrolyte layer 1.

The bonding layer 2 may include a plurality of carbon particles CP1 and CP2 and a binder. The bonding layer 2 further includes a plurality of crystalline particles CRP.

The plurality of carbon particles CP1 and CP2 may include a carbon-based anode active material. The carbon particles CP1 and CP2 of the bonding layer 2 and the carbon particles CP2 of the carbon-based active material layer 3 may include the same carbon-based anode active material.

When the bonding layer 2 is formed together in the process of forming the carbon-based active material layer 3, the material of the carbon particles CP1 and CP2 of the bonding layer 2 may be the same as the material of the carbon particles CP2 of the carbon-based active material layer 3.

For example, the carbon-based anode active material of the bonding layer 2 may include amorphous carbon. The amorphous carbon may be, for example, carbon black (CB), acetylene black (AB), furnace black (FB), Ketjen black (KB), graphene, carbon nanotube, carbon nanofiber, or the like, but is not limited thereto, and may include all those that can be classified as amorphous carbon in the art.

The binder of the bonding layer 2 may include an aqueous binder. When the bonding layer 2 is formed together in the process of forming the carbon-based active material layer 3, the material of the binder of the bonding layer 2 may be the same as the material of the binder of the carbon-based active material layer 3. For example, both the binder of the carbon-based active material layer 3 and the binder of the bonding layer 2 may be aqueous binders. Examples of the aqueous binder may include at least one polymer of polyvinyl alcohol, polyacrylic acid, polymethacrylic acid, polyvinyl alcohol grafted polyacrylic acid, or polyvinyl alcohol grafted polymethacrylic acid, or a copolymer thereof.

The content of the binder in the bonding layer 2 may be about 15 wt % or less. The content of the binder in the bonding layer 2 may be about 7 wt % or less. The content of the binder in the bonding layer 2 may be about 5 wt % or less. The content of the binder in the bonding layer 2 may be about 0.1 wt % to about 15 wt % based on the total weight of the bonding layer 2. The content of the binder in the bonding layer 2 may be about 0.1 wt % to about 7 wt % based on the total weight of the bonding layer 2. The content of the binder in the bonding layer 2 may be about 0.1 wt % to about 5 wt % based on the total weight of the bonding layer 2. The content of the binder in the bonding layer 2 may be greater than a content of the binder in the carbon-based active material layer 3. The content of the binder in the bonding layer 2 may be slightly greater than the content of the binder in the carbon-based active material layer 3. The difference between the binder content of the bonding layer 2 and the binder content of the carbon-based active material layer 3 may be within about 20% of the binder content of the bonding layer 2. For example, when the binder content of the carbon-based active material layer 3 is about 4.5 wt %, the binder content of the bonding layer 2 may be about 5 wt %.

Some of the plurality of carbon particles CP1 and CP2 are surrounded by the coating layer, and the rest of the plurality of carbon particles CP1 and CP2 may not be surrounded by the coating layer. In other words, the plurality of carbon particles CP2 may include first carbon particles CP1 surrounded by a coating layer and second carbon particles CP2 without a coating layer.

The coating layer surrounding or on the carbon particles CP1 may include lithium and oxygen, for example may include a material comprising lithium and oxygen atoms. The coating layer may include at least a part of a material of the solid electrolyte layer 1 and a material of the binder. The coating layer may include a material derived from a material of the solid electrolyte layer 1 and a material of the binder in the bonding layer. For example, when the solid electrolyte layer 1 is an oxide-based solid electrolyte including lithium and oxygen, and the binder is a binder including carbon, hydrogen, and oxygen, the coating layer may include lithium and oxygen. The coating layer may be an organic or inorganic material including lithium and oxygen atoms, and optionally with or without carbon atoms, but is not necessarily limited thereto.

The plurality of crystalline particles CRP may be located adjacent to the surface of the solid electrolyte layer 1 in the bonding layer 2. Each of the plurality of crystalline particles CRP may have a nanometer size. The crystalline particles CRP may be referred to as nanocrystal grains. For example, the crystalline particles CRP may have an average particle diameter of about 100 nanometers (nm) or less. For example, the crystalline particles CRP may have an average particle diameter of about 10 nanometers to about 100 nanometers. The average particle diameter of the crystalline particles CRP may be less than or greater than the average particle diameter of the carbon particles CP2. Here, the average particle diameter is the average particle diameter observed using a scanning electron microscope (SEM), and may be calculated as the average value of the particle diameters of about 10 to 30 particles using the SEM image. When the crystalline particles CRP are non-spherical, the average particle diameter of the crystalline particles CRP may be interpreted as an average major axis length.

The crystalline particles CRP may include lithium, carbon, and oxygen. For example, crystalline particles CRP may be formed in the drying stage in the process of forming the carbon-based active material layer 3 including a binder on the solid electrolyte layer 1. Accordingly, the crystalline particles CRP may be derived (or formed) from or determined by at least one of a material of the solid electrolyte layer 1 and a material of the binder. As used herein, “derived from” or “formed from” means obtained from a reaction between at least one of a material of the solid electrolyte layer 1 and a material of the binder in the bonding layer. For example, the crystalline particles CRP may be derived from or determined by a material of the solid electrolyte layer 1 and a material of the binder. The crystalline particles CRP may include a material derived from a material of the solid electrolyte layer 1 and a material of the binder. For example, the material of the solid electrolyte layer 1 may include lithium and oxygen, and the material of the binder may include carbon and oxygen. For example, when the solid electrolyte layer 1 is an oxide-based solid electrolyte including lithium and oxygen, and the binder is a binder including carbon, hydrogen, and oxygen, the crystalline particles CRP may include lithium, carbon, and oxygen. For example, the crystalline particles CRP may include a material or compound comprising lithium, carbon, and oxygen atoms such as lithium squarate (Li₂C₄O₄).

However, the material of the crystalline particles CRP is not necessarily limited thereto, and some components may be added or changed according to a change of at least one of the material of the solid electrolyte layer 1 and the material of the binder. For example, when the material of the binder used in the bonding layer 2 is changed, the material of the crystalline particles CRP may be changed. As an example, when a fluorine-based binder is used as the binder of the bonding layer 2, the crystalline particles CRP may further include fluorine (F). As another example, when nitrogen or sulfur is included in the binder of the bonding layer 2, the crystalline particles CRP may further include nitrogen (N) or sulfur(S).

The differences between the crystalline particles CRP and the carbon particles CP2 without a coating layer or the carbon particles CP1 surrounded by the coating layer may be confirmed through an SEM, Transmission Electron Microscope (TEM), or the like.

The thickness of the bonding layer 2 may be less than or equal to a predetermined thickness. For example, the thickness of the bonding layer 2 may be about 2 μm or less. For example, the thickness of the bonding layer 2 may be about 1 μm or less. For example, the thickness of the bonding layer 2 may be about 0.5 μm or less. The thickness of the bonding layer 2 may be greater than the average particle diameter of the crystalline particles CRP, for example greater than about 10 nanometers. The thickness of the bonding layer 2 may be about 1 or 1.2 times to about 200 times the average particle diameter of the crystalline particles CRP. The thickness of the bonding layer 2 may be about 1 or about 1.2 times to about 100 times the average particle diameter of the crystalline particles CRP. The thickness of the bonding layer 2 may be about 1 or about 1.2 times to about 50 times the average particle diameter of the crystalline particles CRP.

The thickness of the bonding layer 2 may be less than the thickness of the carbon-based active material layer 3. The thickness of the bonding layer 2 may be less than or equal to about ½ of the thickness of the carbon-based active material layer 3. The thickness of the bonding layer 2 may be less than or equal to about ⅕ of the thickness of the carbon-based active material layer 3. The thickness of the bonding layer 2 may be less than or equal to about 1/10 of the thickness of the carbon-based active material layer 3. The thickness of the bonding layer 2 may be less than or equal to about 1/20 of the thickness of the carbon-based active material layer 3. The thickness of the bonding layer 2 may be greater than or equal to about 1/10000 of the thickness of the carbon-based active material layer 3.

In the carbon-based active material layer 3, a plurality of crystalline particles CRP may not exist or may be present in an amount less than the amount of the crystalline particles CRP in the bonding layer 2. In other words, a content (e.g., weight percent or mole percent) of the crystalline particles CRP included in the carbon-based active material layer 3 may be less than a content (e.g., weight percent or mole percent) of the crystalline particles CRP included in the bonding layer 2.

In the carbon-based active material layer 3, the carbon particles CP1 coated with or surrounded by the coating layer (coated CP1) may not be present or may be present in an amount that is less than the amount of the coated CP1 in the bonding layer 2. In other words, a ratio of the coated CP1 relative to the uncoated CP2 in the carbon-based active material layer 3 may be less than a ratio of the coated CP1 relative to the uncoated CP2 in the bonding layer 2.

Each of the bonding layer 2 and the carbon-based active material layer 3 may further include a metal material. The metal material may include lithium metal, a lithium alloy, or a metal or metalloid anode active material capable of alloying with lithium. Here, the metal or metalloid anode active material may be at least one metal or metalloid of indium (In), silicon (Si), gallium (Ga), tin (Sn), aluminum (AI), titanium (Ti), zirconium (Zr), niobium (Nb), germanium (Ge), antimony (Sb), bismuth (Bi), gold (Au), platinum (Pt), palladium (Pd), magnesium (Mg), silver (Ag), or zinc (Zn).

The intermediate layer 5 may further include a metal-based active material layer 4. The metal-based active material layer 4 may be a layer that reacts with lithium. The metal-based active material layer 4 may induce lithium to be precipitated at a position adjacent to the anode current collector 6 during charging. The metal-based active material layer 4 may prevent the interface between the solid electrolyte layer 1 and the anode from being degraded by adjusting the deposition position of lithium. The metal-based active material layer 4 may be a layer formed separately from other layers of the intermediate layer 5, for example, the bonding layer 2 and the carbon-based active material layer 3. For example, the metal-based active material layer 4 may be formed by deposition on the anode current collector 6 while the bonding layer 2 and the carbon-based active material layer 3 may be formed on the solid electrolyte layer 2.

The metal-based active material layer 4 may include at least one of a lithium metal or a metal or a metalloid capable of alloying with lithium. The metal or metalloid capable of alloying with lithium may be at least one metal or metalloid of indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), silver (Ag), or zinc (Zn).

The thickness of the metal-based active material layer 4 may be greater than 0, greater than or equal to about 0.5 μm, or greater than or equal to about 2 μm but less than or equal to a predetermined thickness. The thickness of the metal-based active material layer 4 may be about 100 μm or less. The thickness of the metal-based active material layer 4 may be about 50 μm or less. The thickness of the metal-based active material layer 4 may be about 30 μm or less. The thickness of the metal-based active material layer 4 may be the thickness of the metal-based active material layer 4 when the all solid secondary battery is in an initial manufacturing state or a discharged state.

The metal-based active material layer 4 may be an optional layer. For example, as shown in FIG. 4, the intermediate layer 5A of the sub-assembly 10A includes the bonding layer 2 and the carbon-based active material layer 3, and may not include the metal-based active material layer 4.

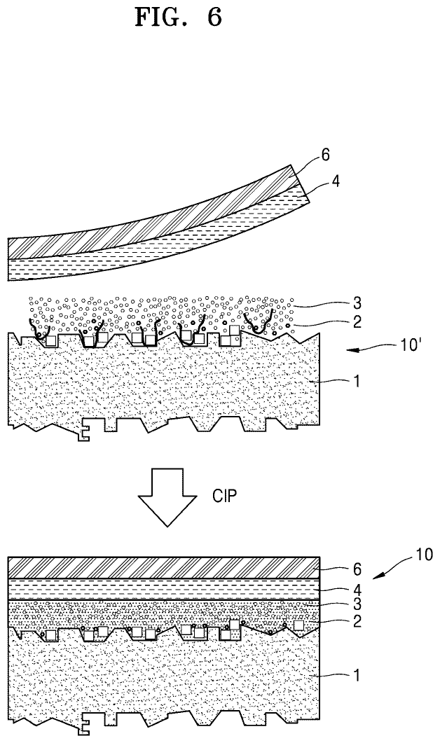

FIG. 5 is a diagram for schematically explaining a part of a process of manufacturing a sub-assembly 10′ of an all solid secondary battery according to an embodiment, and FIG. 6 is a diagram for schematically explaining a process of bonding an anode current collector 6 to the sub-assembly 10′ of FIG. 5.

Referring to FIG. 5, a method of manufacturing the sub-assembly 10′ of an all solid secondary battery according to an embodiment may include applying a carbon material slurry to a surface of a solid electrolyte layer 11′ and drying or evaporating a solvent in the applied carbon material slurry. In the method of manufacturing the sub-assembly 10′, an operation of preparing the solid electrolyte layer 11′ before applying the carbon material slurry to a surface of the solid electrolyte layer 11′ may be included.

The preparation of the solid electrolyte layer 11′ may include an operation of preparing a solid electrolyte molded body 11. The solid electrolyte molded body 11 may be prepared by, for example, heat-treating a precursor of a solid electrolyte material. For example, the solid electrolyte molded body 11 may be prepared by heat-treating a precursor of an oxide-based solid electrolyte material.

The oxide-based solid electrolyte may be prepared by contacting the precursor in a stoichiometric amount to form a mixture and heat treating the mixture. Contacting may include milling or grinding, such as ball milling, for example. The mixture of the precursor mixed with the stoichiometric composition may be subjected to a primary heat treatment in an oxidizing atmosphere to prepare a primary heat treatment product. The primary heat treatment may be performed at a temperature range of less than about 1000° C. and optionally greater than 500° C. for about 1 hour to about 36 hours. The primary heat treatment product may be pulverized. Grinding of the primary heat treatment product may be performed dry or wet. Wet grinding may be performed, for example, by mixing a solvent such as methanol with the primary heat treatment product and then milling with a ball mill for about 0.5 hours to about 10 hours. Dry grinding may be carried out by milling with a ball mill or the like without a solvent. The particle diameter of the pulverized primary heat treatment product may be about 0.1 μm to about 10 μm or about 0.1 μm to about 5 μm. The pulverized primary heat treatment product may be dried. The pulverized primary heat treatment product may be mixed with binders solution to form pellets, or may be simply roll pressed at a pressure of about 1 ton to about 10 ton to form pellets. The molded body may be subjected to secondary heat treatment at a temperature less than about 1300° C. for about 1 hour to about 36 hours. A solid electrolyte molded body 11 as a sintered material is obtained by secondary heat treatment. The secondary heat treatment may be performed at, for example, about 550° C. to about 1300° C. The primary heat treatment time may be about 1 hour to about 36 hours. The molded article may be subjected to a secondary heat treatment in at least one of an oxidizing atmosphere and a reducing atmosphere. The secondary heat treatment may be performed in a) an oxidizing atmosphere, b) a reducing atmosphere, or c) an oxidizing atmosphere and a reducing atmosphere. Alternatively, the oxide-based solid electrolyte may be prepared using a tape casting method. For example, an oxide-based solid electrolyte slurry is prepared by mixing an oxide-based solid electrolyte powder with binders and a solvent. The oxide solid electrolyte slurry can be ball milled for about 12 to about 24 hours and subjected to aging for about 1 to about 4 hours. The oxide solid electrolyte slurry subjected to aging can be poured into a doctor blade set at a predetermined height, and a PET substrate layer can be moved at a speed of about 1.0 m/min to about 3.0 m/min to perform tape casting to obtain a green sheet having a thickness of several tens of micrometers. The green sheet can be sintered at a temperature of about 1,000° C. to about 1350° C. through stacking, pressing, and cutting processes to obtain a sintered body. The solid electrolyte molded body 11 having a thickness of several hundred micrometers may be prepared by putting the sintered body into a mold and applying pressure thereto.

The preparation of the solid electrolyte layer 11′ may include an operation of surface-treating the solid electrolyte molded body 11. The solid electrolyte layer 11′ having an uneven surface may be manufactured by surface-treating the solid electrolyte molded body 11. As an example of surface treatment, an acid treatment method may be used. In the acid treatment method, hydrochloric acid, phosphoric acid, sulfuric acid, nitric acid, hydrofluoric acid, or a mixture thereof may be used. For example, acid treatment may be performed at a concentration of about 0.1 M to about 10 M for about 30 minutes to about 1 hour. For example, acid treatment may be performed with hydrochloric acid at a concentration of about 0.1 M to about 1 M for about 30 minutes to about 1 hour. After the acid treatment, a solvent, for example, ethanol, may be used to wash the acid treated surface, and the solvent washed and acid treated solid electrolyte layer can be dried in a drying room to obtain the solid electrolyte layer 1 having an uneven surface.

The surface of the solid electrolyte layer 11′ may have a predetermined roughness. For example, a plurality of microgrooves MG may be formed on the surface of the solid electrolyte layer 11′. The size of each of the plurality of microgrooves MG may be several hundred nm to several um. For example, the size of the microgroove MG may be greater than about 100 nm and less than about 10 μm. The size of the microgroove may be defined by at least one of the height and width of the microgroove.

The average size of the microgrooves MG may be larger than the average particle diameter of the crystalline particles CRP. The average depth of the microgrooves MG may be larger than the average particle diameter of the crystalline particles CRP. The average width of the microgrooves MG may be larger than the average particle diameter of the crystalline particles CRP.

As described above, before the carbon material slurry is applied to one surface of the solid electrolyte layer 11′, the solid electrolyte layer 1 may have the plurality of microgrooves MG formed on one surface of the solid electrolyte layer 11′ by surface treatment.

Next, a carbon material slurry may be applied to a surface of the solid electrolyte layer 11′. The carbon material slurry may be a mixture of a carbon-based anode active material, a binder, and a solvent. For example, the carbon material slurry may be prepared by adding carbon black powder to a mixture of water and an aqueous binder and stirring the mixture with a mixer. As a method of applying the carbon material slurry, doctor blade, bar coating, screen printing, spray coating, and the like may be used. However, the method of applying the carbon material slurry is not limited thereto, and may be various.

Next, the drying process may be performed in a state in which the carbon material slurry is applied on the solid electrolyte layer 11′. For example, the carbon material slurry applied on the solid electrolyte layer 11′ may be dried at room temperature for about 1 hour or more. The drying time may be about 1 hour or more and about 100 hours or less. The drying time is not necessarily limited thereto, and may be increased or decreased according to the type of solvent.

During the drying process, the solvent of the carbon material slurry is removed, crystalline particles CRP may be formed, and a coating layer may be formed around some of the carbon particles CP1. During the drying process, the bonding layer 2 and the carbon-based active material layer 3 may be formed on the solid electrolyte layer 1.

The crystalline particles CRP may include lithium, carbon, and oxygen. For example, the crystalline particles CRP may be derived from or determined by a material of the solid electrolyte layer 1 and a material of the binder. The crystalline particles CRP may include a material of the solid electrolyte layer 1 and a material of the binder. For example, the material of the solid electrolyte layer 1 may include lithium and oxygen, and the material of the binder may include carbon and oxygen. For example, when the solid electrolyte layer 1 is an oxide-based solid electrolyte including lithium and oxygen, and the binder is a binder including carbon, hydrogen, and oxygen, the crystalline particles CRP may include lithium, carbon, and oxygen. For example, the crystalline particles CRP may include a material or compound comprising lithium, carbon, and oxygen atoms such as lithium squarate (Li₂C₄O₄).

The bonding layer 2 formed during the drying process may include a plurality of carbon particles CP2 and a binder. In the bonding layer 2, particle diameters of the plurality of carbon particles CP1 and CP2 may be smaller than those of the plurality of crystalline particles CRP.

The plurality of carbon particles CP1 and CP2 may include a carbon-based anode active material. The carbon particles CP1 and CP2 of the bonding layer 2 and the carbon particles CP2 of the carbon-based active material layer 3 may include the same carbon-based anode active material.

When the bonding layer 2 is formed together in the process of forming the carbon-based active material layer 3, the material of the carbon particles CP1 and CP2 of the bonding layer 2 may be the same as the material of the carbon particles CP2 of the carbon-based active material layer 3.

For example, the carbon-based anode active material of the bonding layer 2 and the carbon-based active material layer 3 may independently include amorphous carbon. The amorphous carbon may be, for example, carbon black (CB), acetylene black (AB), furnace black (FB), Ketjen black (KB), graphene, carbon nanotube, carbon nanofiber, or the like, but is not limited thereto, and may all be classified as amorphous carbon in the art.

The binder of the bonding layer 2 may include an aqueous binder. When the bonding layer 2 is formed together in the process of forming the carbon-based active material layer 3, the material of the binder of the bonding layer 2 may be the same as the material of the binder of the carbon-based active material layer 3. For example, both the binder of the carbon-based active material layer 3 and the binder of the bonding layer 2 may be aqueous binders. Examples of the aqueous binder may include at least one of polyvinyl alcohol, polyacrylic acid, polymethacrylic acid, polyvinyl alcohol grafted polyacrylic acid, or polyvinyl alcohol grafted polymethacrylic acid, or a copolymer thereof.

The content of the binder in the bonding layer 2 may be about 15 wt % or less. The content of the binder in the bonding layer 2 may be about 5 wt % or less. The content of the binder in the bonding layer 2 may be about 0.1 wt % to about 15 wt % based on the total weight of the bonding layer 2. The content of the binder in the bonding layer 2 may be about 0.1 wt % to about 5 wt % based on the total weight of the bonding layer 2. The content of the binder in the bonding layer 2 may be slightly greater than the content of the binder in the carbon-based active material layer 3. The difference between the binder content of the bonding layer 2 and the binder content of the carbon-based active material layer 3 may be within about 20% of the binder content of the bonding layer 2. For example, when the binder content of the carbon-based active material layer 3 is about 4.5 wt %, the binder content of the bonding layer 2 may be about 5 wt %.

Some of the plurality of carbon particles CP1 and CP2 are coated with or surrounded by the coating layer, and the rest of the plurality of carbon particles CP1 and CP2 may not be coated with or surrounded by the coating layer. In other words, the plurality of carbon particles CP1 and CP2 may include first carbon particles CP1 coated with or surrounded by a coating layer and second carbon particles CP2 without a coating layer. For example, the coating layer surrounding the carbon particles CP1 may include lithium and oxygen.

In the process of applying and drying the carbon material slurry, the binder in the carbon material slurry is mainly distributed in a relatively lower part (the part closer to the solid electrolyte layer 1). The phenomenon in which crystalline particles CRP and carbon particles CP1 coated with or surrounded by the coating layer appear mainly on the surface of the solid electrolyte layer 1 is interpreted as a result of a reaction of the binder distributed adjacent to the surface of the solid electrolyte layer 1 with some components of the solid electrolyte layer 1. When the binder is further away from the solid electrolyte layer 1, a reaction between the binder and the components of the solid electrolyte layer is less likely to occur.

For example, without wishing to be bound by theory, crystalline particles CRP including lithium, carbon, and oxygen can be formed by the reaction of lithium in the solid electrolyte layer 11′, carbon in the binders, and oxygen in the solid electrolyte layer 11′, and oxygen in the binders. For example, the coating layer including lithium and oxygen surrounding the carbon particles CP2 can be formed by reacting lithium in the solid electrolyte layer 11′ with oxygen in the solid electrolyte layer 1 or oxygen in the binders.

The crystalline particles CRP may have a size of about 100 nm or less. The crystalline particles CRP may have an average particle diameter of about 10 nm to about 100 nm. The average particle diameter of the crystalline particles CRP may be less than or equal to the average particle diameter of the carbon particles CP2. For example, when the average particle diameter of the carbon particles CP2 is about 30 nm to about 100 nm, the average particle diameter of the crystalline particles CRP may be about 10 nm to about 100 nm.

Since the crystalline particles CRP are adjacent to the surface of the solid electrolyte layer 1, interfacial bonding force between the bonding layer 2 with the solid electrolyte layer 1 may be improved.

The plurality of crystalline particles CRP may be disposed inside microgrooves MG formed on the surface of the solid electrolyte layer 1. As the plurality of crystalline particles CRP are disposed inside the microgrooves MG, the interfacial bonding force between the solid electrolyte layer 1 and the bonding layer 2 may be further increased.

The separation between the bonding layer 2 and the carbon-based active material layer 3 may be distinguished by at least one of a content of crystalline particles CRP, a ratio of the amount of the carbon particles CP1 having a coating layer formed relative to the amount of the carbon particles CP2 without the coating layer, and the binder content. For example, most of the crystalline particles CRP are distributed in a region adjacent to the surface of the solid electrolyte layer 1. A region in which the crystalline particles CRP mainly exist may be defined as the bonding layer 2, and a region in which the crystalline particles CRP are not present or present in an amount of less than 1 volume % may be defined as the carbon-based active material layer 3. A region in which the crystalline particles CRP are present in an amount of less than 0.5 volume % may be defined as the carbon-based active material layer 3. A region in which the crystalline particles CRP are present in an amount of less than 0.1 volume % may be defined as the carbon-based active material layer 3. Here, “volume %” may be defined as the percentage of volume occupied by the crystalline particles CRP compared to the total volume of the region.

As described above, by reducing the thickness of the bonding layer 2, it is possible to improve the interfacial bonding and prevent an increase in interfacial resistance.

As described above, through a process of applying and drying a carbon material slurry on a surface of the solid electrolyte layer 1, a sub-assembly 10′ in which the bonding layer 2 and the carbon-based active material layer 3 are sequentially disposed on the solid electrolyte layer 1 may be provided.

Although not shown, a pre-lithiation process may be performed on the sub-assembly 10. Through the pre-lithiation process, a decrease in the initial Coulombic efficiency (ICE) may be prevented. However, the pre-lithiation process is optional and may be omitted, if necessary.

FIG. 6 is a diagram describing a process of arranging an anode current collector 6 in a sub-assembly 10 of an all solid secondary battery according to an embodiment.

Referring to FIG. 6, the metal-based active material layer 4 and the anode current collector 6 may be disposed on a sub-assembly 10′ in which the bonding layer 2 and the carbon-based active material layer 3 are disposed on the solid electrolyte layer 1.

As an example, the method of manufacturing the sub-assembly 10 may further include forming the metal-based active material layer 4 on the anode current collector 6.

The metal-based active material layer 4 may be provided on the anode current collector 6. For example, the metal-based active material layer 4 may be formed on the anode current collector 6 by deposition. As a non-limiting example of the deposition method, a sputtering method may be used. However, the forming method of the metal-based active material is not limited to the deposition method, and may be variously modified.

In a state in which the metal-based active material layer 4 is provided on a surface of the anode current collector 6, the anode current collector 6 may be disposed on the carbon-based active material layer 3 of the sub-assembly 10 such that the metal-based active material layer 4 faces the carbon-based active material layer 3.

The sub-assembly 10 may be manufactured through a bonding process in which the metal-based active material layer 4 and the carbon-based active material layer 3 are in contact with each other. For example, the sub-assembly 10 in which the solid electrolyte layer 1, the bonding layer 2, the carbon-based active material layer 3, the metal-based active material layer 4, and the anode current collector 6 are stacked may be manufactured by pressing the solid electrolyte layer 1 and the anode current collector 6 so that the carbon-based active material layer 3 and the metal-based active material layer 4 are bonded to each other by using a cold isostatic pressing (CIP) method.

Hereinafter, Examples and Comparative Examples of the inventive concept will be described. However, the following Examples are only Examples of this inventive concept, and this inventive concept is not limited to the following Examples.

### Examples

### Example 1: Manufacture of All Solid Secondary Battery

### Production of Sub-Assembly

Ta-doped solid electrolyte pellets having a thickness of about 500 μm and a diameter of about 14 mm represented by Li_{6.5}La₃Zr_{1.5}Ta_{0.5}O₁₂ (LLZO, Toshima Co.) were prepared.

An LLZO solid electrolyte was acid-treated with about 1 M hydrochloric acid for about 30 minutes, washed with ethanol, and dried in a drying room to provide a solid electrolyte layer of solid electrolyte pellets of Li_{6.5}La₃Zr_{1.5}Ta_{0.5}O₁₂ having an uneven surface.

Separately, carbon black CB (ENSACO 250G, Imerys Co.) powder was added to a mixture of water and polyvinyl alcohol grafted polyacrylic acid (PVA-g-10PAA), that is, a water-soluble binder, and stirred with a mixer (Thinky Corporation, AR-100) to prepare a carbon material slurry. The polyvinyl alcohol grafted polyacrylic acid (PVA-g-10PAA) was synthesized by graft polymerizing an acrylic acid monomer on a polyvinyl alcohol backbone according to the method disclosed in reference J. He, L. Zhang, Journal of Alloys and Compounds 763 (2018) 228-240.

A carbon material slurry was applied to one surface of a solid electrolyte layer of solid electrolyte pellets of Li_{6.5}La₃Zr_{1.5}Ta_{0.5}O₁₂. The carbon material slurry applied on the solid electrolyte layer was dried at room temperature for about 1 hour or more to prepare a solid electrolyte layer in which the bonding layer and the carbon-based active material layer were formed. The content of the polyvinyl alcohol grafted polyacrylic acid was about 5 wt % based on the total weight of the binder layer and the carbon-based active material layer.

Additionally, an about 10 μm thick copper foil deposited with about 20 μm thick metallic lithium was arranged on the carbon-based active material layer, and pressure was applied to complete a sub-assembly stacked in the order of the solid electrolyte layer, the bonding layer, the carbon-based active material layer, the metal-based active material layer, and the anode current collector.

### Production of Cathode

LiCoO₂ (LCO) (Samsung SDI) was prepared as a cathode active material. Carbon black (Super P° Li, Imerys Co.) was prepared as a conductive material. Polyvinylidene fluoride (Solef®5130, Solvay Co.) was prepared as a binder. The binder was used in the form of a solution of polyvinylidene fluoride dissolved in N-Methyl-2-pyrrolidinone (NMP) at a ratio of about 5 wt %. Subsequently, these materials were mixed in a weight ratio of a cathode active material: a conductive material: binders=94:3:3 to prepare a composition for forming a cathode active material layer. The composition was coated to a thickness of about 46 μm on an aluminum foil (Nippon Foil Mfg. Co., LTD) current collector having a thickness of about 9 μm using an applicator, dried at about 120° C. for about 12 hours, and compressed to manufacture a cathode including a cathode active material layer.

The produced cathode active material layer of the cathode was wetted in an electrolyte in which about 2.0 M of lithium bis(fluorosulfonyl) imide (LIFSI, 99.9%, water content <about 10 ppm), was dissolved in 1-ethyl-3-methylimidazolium bis(fluorosulfonyl)imide (EMIM-FSI, 99.9%, water content <about 20 ppm) which is an ionic liquid.

### Production of All Solid Secondary Battery

The cathode was arranged on the sub-assembly of the anode-solid electrolyte layer and sealed in a vacuum state to manufacture an all solid secondary battery.

### Example 2: Manufacture of All Solid Secondary Battery

When preparing the carbon material slurry, the same binder as the binder in Example 1 was used, and the binder content was doubled. Other compositions and operations were carried out in the same manner as in Example 1 to manufacture an all solid secondary battery.

Comparative Example 1: Manufacture of all solid secondary battery

An all solid secondary battery was manufactured in the same way as in Example 1, except that a sub-assembly of a carbon-based active material layer-solid electrolyte layer was obtained in accordance with the following method.

In Comparative Example 1, a carbon material slurry was applied to SUS foil instead of directly applying the carbon material slurry to the solid electrolyte layer, dried, and then a carbon-based active material layer was arranged on the solid electrolyte layer to face each other and pressure was applied to prepare a solid electrolyte layer/carbon-based active material layer sub-assembly.

Afterwards, as in Example 1, a copper foil with a thickness of about 10 μm on which metal lithium with a thickness of about 20 μm was deposited was arranged on the carbon-based active material layer, and pressure was applied at about 25° C. to about 250 MPa for about 3 minutes by cold isotactic pressing (CIP) to complete a sub-assembly stacked in the order of solid electrolyte layer/carbon-based active material layer/metal-based active material layer/anode current collector.

The composition of the carbon material slurry used in Comparative Example 1was the same as the composition of the carbon material slurry used in Example 1, and the drying process of Comparative Example 1 was also performed under the same conditions as the drying process of Example 1.

### Evaluation Example 1: SEM Analysis

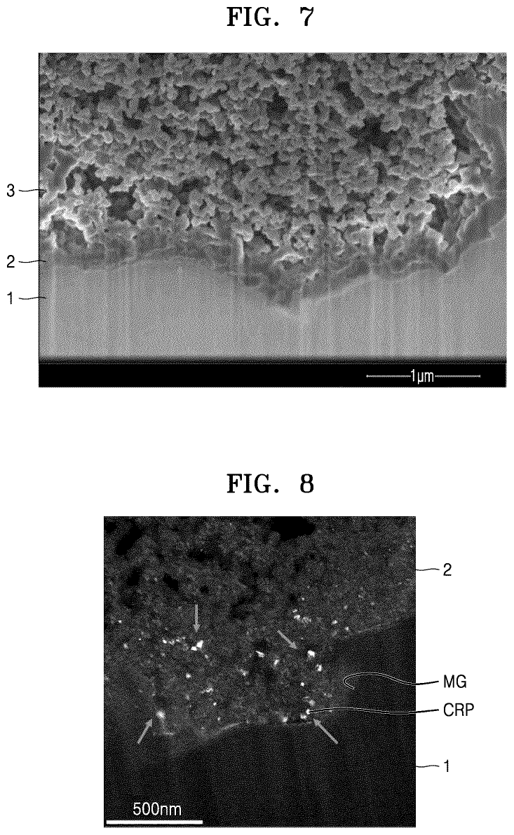

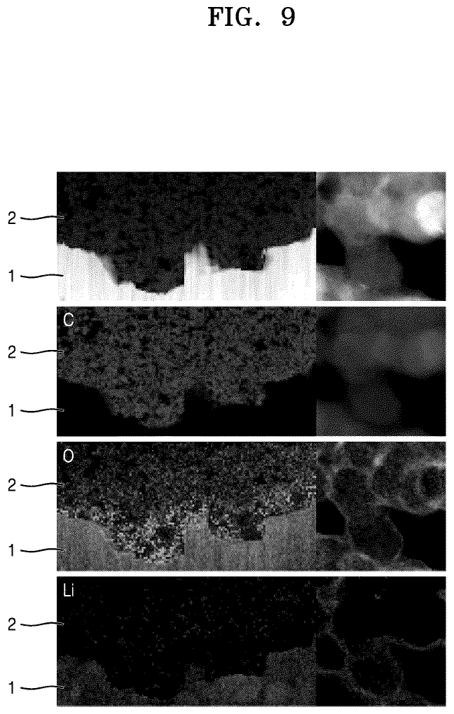

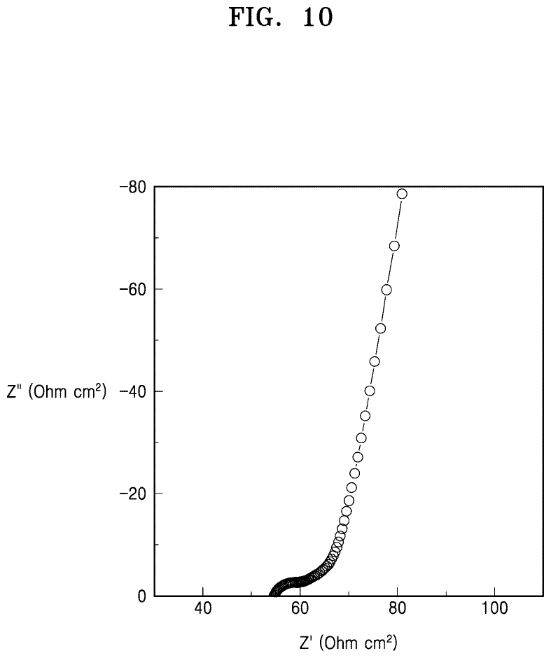

FIG. 7 is a SEM analysis image of a sub-assembly according to an embodiment, and FIG. 8 is an enlarged view of a portion of FIG. 7. FIG. 9 is an electron energy loss spectroscopy (ELS) image of a bonding layer adjacent to a surface of a solid electrolyte layer according to an embodiment.

Referring to FIGS. 7 and 8, the all solid secondary battery prepared according to Example 1 was decomposed to perform scanning electron microscope analysis on the sub-assembly of the anode-solid electrolyte layer.

Referring to FIG. 7, it could be seen that in the sub-assembly of the anode-solid electrolyte layer of Example 1, the bonding layer 2 and the carbon-based active material layer 3 are sequentially formed on the solid electrolyte layer 1. Referring to FIG. 8, it may be observed that white parts (crystalline particles including lithium, carbon, and oxygen) are present adjacent to the surface of the solid electrolyte layer 1 in the bonding layer 2. It could be seen that the surface of the surface-treated solid electrolyte layer 1 is in a state in which a plurality of microgrooves MG are formed, and white parts are inserted into the microgrooves MG formed on the surface of the solid electrolyte layer 1.

In addition, referring to FIG. 9, the EELS image shows that the coating layer surrounding the edge of the carbon particles includes lithium and oxygen in the bonding layer 2 adjacent to the solid electrolyte layer 1.

Evaluation Example 2: Interface Resistance Evaluation

The sub-assemblies prepared in Example 1 and Comparative Example 1 were prepared, and an ionic liquid and a cathode were brought into contact with each other to prepare a cell having a hybrid electrolyte structure. Interfacial resistance was confirmed for each cell of Example 1 and Comparative Example 1 through electrochemical impedance spectroscopy (EIS) analysis. For each cell, the impedance of the pellet was measured at about 25° C. in an air atmosphere by a 2-probe method using an impedance analyzer (Solartron 1400A/1455A impedance analyzer). A frequency range was about 0.1 Hz to about 1 MHz, and an amplitude voltage was about 10 mV.

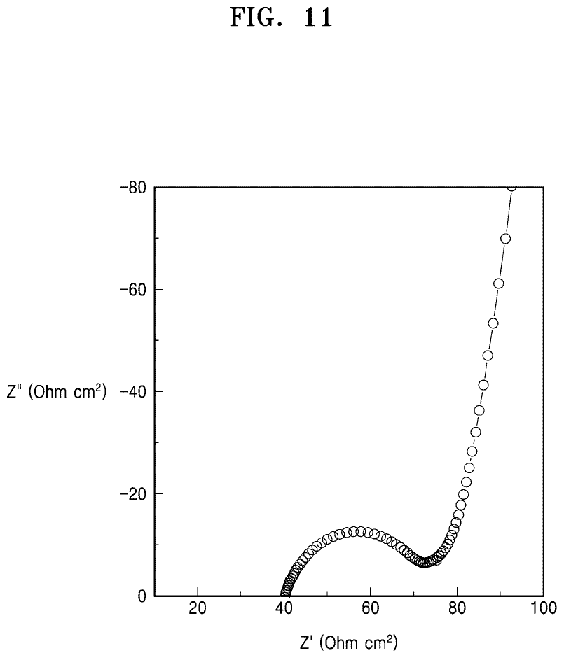

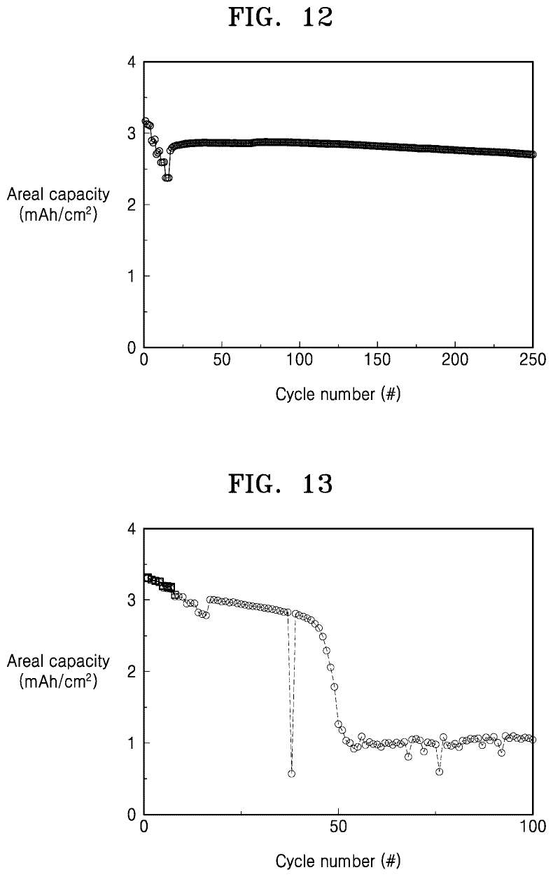

A Nyquist plot of the impedance measurement results of each cell of Example 1 and Comparative Example 1 is shown in FIGS. 10 and 11.

Referring to FIG. 10, the interfacial resistance of the sub-assembly of Example 1 was about 10 Ohm cm² or less, while referring to FIG. 11, the interfacial resistance of the sub-assembly of Comparative Example 1 was about 30 Ohm cm². The interfacial resistance according to Example 1 was significantly reduced compared to the interfacial resistance according to Comparative Example 1. From this, it could be seen that the interface resistance could be reduced to about 1/3 due to the bonding layer including a plurality of crystalline particles.

### Evaluation Example 3: Charge/Discharge Test

The charge and discharge characteristics of the all solid secondary batteries prepared in Example 1 and Comparative Example 1 were evaluated by the following charge and discharge test. For the charging and discharging test, charging and discharging were performed at a current density of about 1.6 mA/cm² at about 25° C. in order to confirm the driving characteristics of the high current density state of the all solid secondary battery.

The all solid secondary battery of Example 1 performed 250 cycles of charging and discharging without a short circuit. However, the capacity of the all solid secondary battery of Comparative Example 1 sharply decreased after 40 times of charging and discharging. Accordingly, it was confirmed that the all solid secondary battery of Example 1 maintains a stable interface during a charging and discharging process by having a bonding layer having a plurality of crystalline particles. It could be seen that the interfacial bonding force of the anode to the solid electrolyte was improved through the bonding layer.

The sub-assembly of the all solid secondary battery according to an aspect and the all solid secondary battery including the same may reinforce a mechanical structure and minimize an increase in interface resistance even during repeated charging and discharging as a plurality of crystalline particles are arranged on the bonding layer in contact with the solid electrolyte layer.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A sub-assembly of an all solid secondary battery, the sub-assembly comprising:
a solid electrolyte layer; and an anode on the solid electrolyte layer, wherein
the anode comprises:
an anode current collector;
a carbon active material layer between the anode current collector and the solid electrolyte layer and including a plurality of first carbon particles; and
a bonding layer between the solid electrolyte layer and the carbon active material layer and contacting a surface of the solid electrolyte layer, wherein
the bonding layer comprises:
a plurality of second carbon particles; and
a plurality of crystalline particles of a material comprising lithium, carbon, and oxygen atoms.

2. The sub-assembly of claim 1, wherein at least a portion of the plurality of the first carbon particles or the second carbon particles are coated with a coating layer including a material comprising lithium and oxygen atoms.

3. The sub-assembly of claim 1, wherein the plurality of the first carbon particles of the carbon active material layer and the plurality of the second carbon particles of the bonding layer comprise a same carbon anode active material.

4. The sub-assembly of claim 1, wherein
the bonding layer further comprises a first binder, and
the crystalline particles comprises a material derived from a material of the solid electrolyte layer and a material of the first binder.

5. The sub-assembly of claim 4, wherein
the material of the solid electrolyte layer comprises lithium and oxygen atoms, and
the material of the first binder comprises carbon and oxygen atoms.

6. The sub-assembly of claim 4, wherein
the carbon active material layer further comprises a second binder, and
a content of the first binder in the bonding layer is greater than a content of the second binder in the carbon active material layer.

7. The sub-assembly of claim 1, wherein an average particle diameter of the crystalline particles is about 100 nm or less.

8. The sub-assembly of claim 1, wherein a surface of the solid electrolyte layer in contact with the bonding layer has a plurality of microgrooves.

9. The sub-assembly of claim 8, wherein at least a portion of the crystalline particles are disposed inside the microgrooves.

10. The sub-assembly of claim 1, wherein a thickness of the bonding layer is 1 μm or less.

11. The sub-assembly of claim 1, further comprising a metal active material layer between the anode current collector and the carbon active material layer and including lithium or a metal alloyable with lithium.

12. The sub-assembly of claim 1, wherein the solid electrolyte layer comprises an oxide solid electrolyte, a sulfide solid electrolyte, a polymer solid electrolyte, or a combination thereof.

13. An all solid secondary battery comprising:
a cathode including a cathode current collector and a cathode active material layer; and
the sub-assembly according to claim 1.

14. A method of manufacturing a sub-assembly, the method comprising:
applying a carbon material slurry including a carbon anode active material, a solvent, and a binder to a surface of a solid electrolyte layer; and
drying the carbon material slurry applied to the surface of the solid electrolyte layer, wherein
in the drying of the carbon material slurry applied to the surface of the solid electrolyte layer, a bonding layer and a carbon active material layer are formed on the surface of the solid electrolyte layer,
the carbon active material layer comprises a first plurality of the carbon particles, and
the bonding layer comprises a second plurality of the carbon particles and a plurality of crystalline particles of a material comprising lithium, carbon, and oxygen atoms.

15. The method of claim 14, wherein,
before applying the carbon material slurry to the surface of the solid electrolyte layer, the solid electrolyte layer comprises a plurality of microgrooves formed on the surface of the solid electrolyte layer by surface treatment, and
in the drying of the carbon material slurry, at least a portion of the plurality of crystalline particles are formed inside the plurality of microgrooves.

16. The method of claim 14, wherein
the bonding layer comprises the binder, and
the crystalline particles comprises a material derived from a material of the solid electrolyte layer and a material of the binder.

17. The method of claim 16, wherein
the carbon active material layer further comprises the binder, and
a content of the binder in the bonding layer is greater than a content of the binder in the carbon active material layer.

18. The method of claim 14, wherein, in the drying of the carbon material slurry, a portion of the second plurality of carbon particles of the bonding layer are coated with a coating layer including a material comprising lithium and oxygen atoms.

19.The method of claim 14, wherein the carbon particles of the carbon active material layer and the carbon particles of the bonding layer comprise a same carbon active material.

20. The method of claim 14, further comprising:
forming a metal active material layer on the cathode current collector; and
arranging an anode current collector on the solid electrolyte layer, on which the bonding layer and the carbon active material layer are arranged, such that the metal active material layer faces the carbon active material layer, and bonding the metal active material layer and the carbon active material layer to each other.
